(19) United States
(12) Patent Application Publication
(10) Pub. No.: US 2023/0245792 A1
(43) Pub. Date: Aug. 3, 2023

(54) INCREASING ENERGY GAIN IN MAGNETICALLY CONFINED PLASMAS BY INCREASING THE EDGE TEMPERATURE: THE SUPER-XT DIVERTOR

(71) Applicant: Michael T. Kotschenruether, Austin, TX (US)

(72) Inventor: Michael T. Kotschenruether, Austin, TX (US)

(73) Assignee: Fusion Energy Associates LLC, Austin, TX (US)

(21) Appl. No.: 18/102,698

(22) Filed: Jan. 28, 2023

Related U.S. Application Data
(60) Provisional application No. 63/304,310, filed on Jan. 28, 2022.

(51) Int. Cl. G21B 1/05

(52) U.S. Cl. CPC G21B 1/052; G21B 1/057

(57) ABSTRACT

A toroidally confined plasma vessel with a substantially symmetric magnetically confined plasma region where a plurality of magnetic field coils are configured to provide at least one X-point, and to guide plasma particles from the magnetically confined region to the divertor target; and wherein the total magnetic field strength (comprising all components of the magnetic field) at the divertor target is lower than the total magnetic field strength (comprising all components of the magnetic field) of a position in the SOL between the divertor target and X-point on the last closed flux surface that is nearest to it. When the mean free path of the neutrals is longer than the width of the SOL, one can separate the two critical functions: a) withstanding high-heat flux, and b) pumping of plasma particles to maintain a low density.

### CROSS-REFERENCE TO RELATED APPLICATIONS

This application claims priority to provisional application Ser. No. 63/304,310 filed on Jan. 28, 2022.

### FIELD OF INVENTION

This invention generally relates to magnetically confined plasmas for producing nuclear fusion reactions.

### BACKGROUND OF THE INVENTION

Magnetically Confined (MC) plasmas must maintain temperatures on the order of 100 million degrees. This is about 10 kilo electron Volts (keV) in units for temperature used within the art. These temperatures are necessary to produce intense thermonuclear fusion reactions. This is needed for fusion to be a useful energy source, for which, the fusion energy produced must be many times greater than the energy that is required to keep the MC plasma hot. The ratio of the energy produced to the energy input is called the fusion gain. (This quotient is usually denoted by Q.)

As is well known in the art, energy gain is strongly dependent upon what is called the energy confinement time—typically the time in which the MC plasma will lose its high-temperature state. A high energy-confinement time is essential for a fusion device. And even for fusion devices where energy gain is not the main goal, for example, where fusion neutrons are used for transmutation, high confinement makes the device much less expensive to run (by reducing expensive energy inputs).

Many consider the MC concept to be the leading one to achieve energy gain greater than one. Attaining energy gain is not easy: after decades of effort and billions of dollars of expenditures in many different countries, the energy confinement is still somewhat too small for energy gain. For the near future, two major magnetic confinement experiments are being built to achieve Q>1—ITER (an international effort by governments), and SPARC (by the private company Commonwealth Fusion Systems). Both of these devices, however, are large and expensive, and the likelihood of their achieving sufficient energy confinement for high energy gain is far from certain.

### SUMMARY OF THE PRIOR ART

The present invention is a means to greatly increase the energy confinement of a wide variety of MC plasmas, so that high energy gain becomes possible. Equally important is the fact that our invention will enable achieving high fusion gain in much smaller and cheaper devices.

Devices that use MC plasmas employ the following principle, which is well known in the art. Strong magnetic fields guide high-temperature particles so that they travel round and round in a toroidal region without ever hitting a material wall. This prevents the plasma from quickly loosing energy to the wall. It also prevents the wall from being destroyed by the thermonuclear plasma, which must be far hotter than any material can tolerate for an extended period.

Within the art, the understanding of the processes that control confinement have improved enormously over the years. The applicants of the present patent application have published dozens of peer-reviewed scientific papers on this subject, and have been central participants in building the scientific understanding of this subject. Based upon this understanding, the energy confinement in the MC region will be greatly improved if the temperature at its edge is increased. It will also be improved if the density at its edge is decreased relative to the core (in appropriate conditions). Lower plasma edge density strongly tends to go together with a higher edge temperature. Low density is nearly as important as high temperature in order to increase confinement. For our purposes here, it suffices that it seems intuitively obvious that raising the temperature of the edge of the MC regions would make it easier to achieve high temperature in its center. Deeper scientific understanding reveals that this is true even more strongly than simple intuition would suggest: even a moderate increase in the boundary temperate can decrease the energy losses by a disproportionate amount. And a lower edge density can also decrease the energy losses by a surprising degree. This is the route that our invention uses to improve energy confinement.

However, several major and potentially disqualifying problems can arise when the temperature of the boundary of the MC region is high and the edge density is low. These problems arise, ultimately, from the interactions of the plasma with the wall with which it must, eventually, come into contact. The present invention is a way to, simultaneously, create a high-temperature boundary and low-density boundary, and to overcome plasma-wall interaction problems. Consequently, this invention insures greatly improved energy confinement of the MC region in a workable, smaller device. The applicant of this patent application has also published numerous peer-reviewed scientific papers on subjects related to the interaction of plasmas with walls, especially, on what is called the divertor, which is where the most intense interactions of the plasma and wall occur.

Let us focus our attention on this region near the edge. As is well known in the art, the MC region has a limited extent. By this, we mean that the region where the particles go round and round without hitting a wall has a limited extent. Within the art, the boundary of this region is called the “Last Closed Flux Surface”, or LCFS. Outside of the LCFS, the magnetic fields guide a particle to intersect with a wall in a fairly short distance. This is extremely different from the region inside. Introducing another term from the art: the plasma in the region outside the LCFS is called the Scrape Off Layer (SOL). And here is another term as well: the region near where the plasma interacts with the wall is called the divertor. And another term is that the plasma strikes the material wall at location called the divertor target. A representative geometry of the previous art, including the positions of the terminology used here, is shown in FIG. 1.

One of the applicants of the current patent application is one of the inventors listed in a previous patent which was granted, and which incorporates a kind of divertor of their invention, called the super-X divertor. An actual geometry from an experiment on the tokamak MAST-U is shown in FIG. 1B. MAST-U is a major experiment in the United Kingdom that was designed specifically to test the Super-X divertor. Notice that the divertor target is in a large chamber. The function of this chamber is to trap neutral atoms and molecules (called neutrals), so that they bounce around and interact repeatedly with the plasma, and repeatedly interact with the wall. These neutral interactions remove the energy from the plasma, and transfer energy from the neutrals to the wall so that the neutrals have low energy, and disperses the energy over the wall of the chamber. All of these interactions work together to minimize damage to the wall. This is an excellent strategy to protect the wall, but it comes at a high cost: the SOL has relatively high density and low temperature. This gives the core MC plasma a boundary condition which is far from the optimum one for its confinement. (Recall that the SOL near the MC plasma is also essentially the boundary of the MC plasma.) Low confinement will reduce the fusion gain in the MC plasma in comparison to a boundary condition with high temperature and low density. The divertor disclosed in this patent adopts a very different strategy. It aims to create a high-temperature, low-density SOL, and hence much higher confinement for the MC plasma. We call the divertor that embodies this strategy a Super-XT divertor. To achieve the desired SOL conditions of high temperature and low density, the interaction of neutrals with the plasma must be reduced. When there is a high-temperature plasma, neutral also have high energy, and they damage the walls, rather than protect it. So, to avoid damage to the walls (and also production of impurities that contaminate the plasma due to sputtering of the wall), the interaction of neutrals with the walls must also be reduced. This is a reverse strategy to the Super-X divertor in the MAST-U device. And hence, very different strategies are necessary to make the plasma compatible with the walls, i.e., to avoid damaging the walls or contaminating the MC plasma. The fact that the name “Super-XT” has only one additional letter of the alphabet does not mean that it is obvious how to take the Super-X and adapt it to the exact opposite or reverse strategy—far from it. One certainly cannot carry over any previous element of the Super-X divertor to the Super-XT, without careful and non-obvious analysis of whether it fits into the totally new strategy. And although this analysis reveals that there are some aspects of the Super-X concept that are useful for the new invention, there are many other new aspects that are needed too. We describe this below.

In order to understand the originality of the present invention, we first describe and discuss a host of problems that arise from the SOL plasma interaction with the wall. This will help us understand: 1) why the present art has not succeeded in achieving high energy confinement by having a high-temperature boundary for the MC region, and 2) why and how the present invention will solve these problems and open an efficient pathway to fusion.

The flow of heat is one of the essential aspects of an MC plasma, and we begin there. As in basic thermodynamics, heat goes from hot to cold. Starting from the center of the MC region, heat travels slowly to the cooler boundary, the LCFS. The heat then continues its journey to the much colder wall by traveling through the SOL plasma. In the journey in the SOL, heat is carried by particles. By traveling along the magnetic field, the SOL plasma particles go to the wall as fast as they can. The characteristic time for this “travel” is very small: it is orders of magnitude shorter than the time for heat to traverse the MC region.

Unsurprisingly, the fact that heat rapidly leaves the SOL results, typically, in the SOL being far colder than the center of the MC region. The SOL is at the boundary of the MC region, and when it is cold, so is that boundary. And as we mentioned before, a cold boundary causes heat to leak out substantially faster from the bulk region of the MC as well.

These very basic considerations lead to the problem that within the standard approaches in the art, a large and expensive device is needed to attain high confinement and large energy gain; both ITER and SPARC are examples.

If the temperature of the LCFS could be raised, the confinement of the MC region would be greatly improved. Lowering the density at the LCFS, relative to the MC region as a whole, can also give considerable improvement to its confinement.

Since the SOL is in contact with the relatively cold wall, it is difficult to raise the SOL temperature. But there is one way to have a high temperature in the SOL—by greatly lowering the density of the SOL. In its journey through the SOL, heat will be carried to the wall by very few particles and consequently, each particle must carry a lot of energy. This is the same as saying that the temperature of the SOL is high.

This strategy in the SOL also combines both elements of the strategy needed to increase confinement in the MC plasma, since the SOL and the LCFC are adjacent—raising the temperature and lowering the density of the LCF S.

Despite these advantages for the MC plasma, an SOL plasma with high temperature and low density leads to other severe challenges arising due to the interaction of the SOL plasma with the wall. The problems arise mainly in the divertor region, where the interactions are most intense. As we will see, some aspects of the super-X divertor are indeed among the key elements of the present invention. But multiple new aspects are needed as well.

To understand the need for a new invention, we must first describe all the new and potentially disqualifying problems that arise from a high-temperature, low-density SOL.

The wall would be unacceptably damaged in three ways: 1) the heat flux would melt the wall where the SOL strikes it, 2) the high-energy particles in the SOL would knock off atoms of its surface, unacceptably eroding it, and 3) This eroded material would also redeposit in other places in the machine, leading to an unacceptable build-up of material where it does not belong and so cause malfunctions.

Before describing these in more detail, we first introduce some more of the standard nomenclature of the field. The material where most of the heat strikes a material wall is called the divertor target. Even with the best cooling that is practical within the standard art, the heat flux would likely melt through the wall if one applied that standard art to an SOL with high-temperature and low density. This could take merely seconds. If this problem could somehow be avoided, then on a longer timescale, erosion and redeposition processes would ruin the components facing the plasma. This would take on the order of days, which is far too short a time for one to simply replace such components. Replacement of large solid components is estimated to take in the range of months, for analysis of fusion designs within the art.

The interaction of a high-temperature SOL with the wall would harm more than the wall: it would also unacceptably degrade the MC plasma by contamination with impurities, as mentioned above. This happens because atoms of the wall will be knocked out by a high-temperature SOL plasma. This is physically inevitable because those atoms are bound to materials with a strength on the order of eV, but high-energy SOL particles have energies orders of magnitude higher. So, collisions of SOL particles with the wall result in a well-known process of “sputtering”: knocking some of its atoms out of the surface. An unacceptable number of these sputtered wall atoms could reach the MC plasma, by two possible routes. One is that the atoms become ionized in the SOL plasma. They then are subject to the influence of the magnetic field, and travel to the MC boundary through the SOL, where they would be absorbed. The other route would be that some sputtered particles are not ionized, and remain neutral, and travel to the MC region along a straight line that is unaffected by the magnetic field. Upon reaching the MC plasma, they would be ionized and absorbed.

Once impurities are absorbed into the MC plasma, they can cause unacceptable results, that are well known in the art. One is that impurities would greatly dilute the energy producing fuel in the MC region, and thus greatly reduce the energy production. Even more seriously, the impurities can cause high-energy X-ray photon radiation to be produced upon being bombarded by the high-energy electrons in the plasma. (This physical process is similar to that in an ordinary medical X-ray tube, where materials are impacted by electrons to make X radiation.) The energy of the MC plasma would be converted to these X-ray photons. The energy losses from this radiation can be very large, even for only a small impurity fraction, and this is known to lead to a total collapse of the MC plasma temperature.

Another way that impurities can be generated is by simply overheating the divertor target, so that ordinary evaporation becomes large. Once they are vaporized, the atoms can get to the MC plasma by the same two routes.

By means of the processes above, the impurities would build up to unacceptable levels over a time on the order of seconds, which is far too rapid for a practical device.

There is one particular impurity that is special, because it is created inside the MC plasma itself, due to fusion reactions: the so called helium “ash” that is a byproduct of fusion reactions. This ash must be exhausted from the plasma as fast as it is generated, otherwise, it will build up in the plasma and dilute the fusion fuel, eventually drastically reducing the fusion rate. Such a build-up is sometimes refereed to, in the art, as choking off the fusion reaction due to the helium ash.

To summarize, there are five serious problems that arise when a high-temperature, low-density SOL plasma interacts with the divertor target, which we call the “SOL Issues”:
1) Unacceptable heat flux on the wall, leading to unacceptable melting or evaporation of it
2) Unacceptable impurity accumulation in the MC plasma, due to sputtering and evaporation
3) Unacceptable erosion of the divertor target by sputtering or evaporation
4) Unacceptable redeposition of the eroded material in Issue #3
5) Unacceptable exhaust of helium

In the following, we will continue to use the name “SOL Issues” as an abbreviation for the five problems listed immediately above.

It is important to realize that if ANY ONE of these issues is not resolved in a device, then that device will not be a practical energy source (or neutron source).

However, it is also important to distinguish two different classes of device in the commercial sector with MC plasmas. Some of the issues above apply more strongly to one type than another. The first type of device has a high duty cycle, that is, they operate for a substantial fraction of the time. Devices to produce useful energy gain or neutron production are of this type. The second type of device has low duty cycle. These can operate with pulse in the range of seconds or minutes, followed by long periods with no operation. Devices with low duty cycle are usually research devices that are prototypes to develop devices of the first type. Some, but not all, examples of commercial devices with short duty cycle are SPARC, being built by the company Commonwealth Fusion Systems, and ST40, which is currently operated by the company Tokamak Energy Ltd. And ITER is a research device built according to an international agreement among governments.

All of the SOL Issues, mentioned above, have serious repercussions for devices of the first type, i.e., those with high duty cycles. However, devices with low duty cycle are primarily affected by the first two SOL Issues, and possibly the fifth.

The current invention avoids all these problems. Before we describe its detailed working, we will summarize attempts to resolve the SOL Issues in the previous art; the need for the present invention will be made eminently clear.

By far, the most common resolution of the SOL Issues in the previous art is to stay away from an SOL that has high temperature and low density because the pertinent issues are regarded as too daunting to solve. In fact, both ITER and SPARC choose an opposite operation scenario-create an SOL with as low a temperature, and as high a density as is practical.

It is generally acknowledged within the art that operating in this conventional way usually leads to some degree of confinement degradation. In the conventional approach, the SOL is regarded NOT as a possible means by which much better core performance could be engineered, but rather, as a source of problems that are so difficult to solve that one is willing to tolerate some degradation of core performance. This is very different from the approach in the present invention. Let us consider how the five SOL Issues are resolved in the conventional approach.

The high heat flux at the divertor target (Issue #1) has been widely analyzed and is acknowledged to be a serious issue. One element of the solution in the conventional approach is to use highly refractory metals as the divertor target (e.g. Tungsten or Molybdenum). But this is acknowledged to be insufficient, in and of itself. The conventional solution must be augmented by creating conditions—keeping the plasma temperature as low as possible near the divertor target, say about 10 eV or less—that disperse energy in the SOL plasma by enhanced radiation near the target. These temperatures are enormously less than the KeV range contemplated in the present invention.

Since such a high level of radiation is not possible for the high-temperature, low-density SOL of this invention. Therefore, managing the heat flux by other means emerges as one key requirement for success.

The standard approach, because of the low temperatures, has greatly reduced sputtering. Impurity build-up in the MC plasma (Issue #2), thus, is also greatly reduced.

Such low temperatures also drastically reduce the divertor target erosion due to sputtering (Issue #3). Let us estimate how problematic it would be to operate a high-temperature, low-density SOL in a conventional divertor. For typical parameters, it would result in an erosion of the divertor target to a depth on the order of a millimeter per day. A solid divertor target can only be up to about a cm thick in order to conduct heat away adequately. So the target would need to be replaced about once per week, but such a replacement will likely take months, so this is unacceptable.

Quite apart from erosion of the divertor target, the eroded material would also redeposit in very undesirable places (Issue #4). As is known in the art, much of this redeposition would likely in the form of dust. This would likely contaminate the plasma by dropping off the wall after it accumulates for a while. This process has been observed in operating devices (for example the Large Helical Device), where dust impinging on the MC plasma causes such high contamination that the plasma terminates. In addition, dust could accumulate in locations including plasma diagnostic ports, Radio Frequency antennas for heating and current drive, etc. This would eventually lead to a malfunction of these crucial systems. It would also create a safety hazard in a fusion device, where the dust would be radioactive, and fine dust can be dispersed through the atmosphere in an accident.

Dust is already acknowledged as a serious problem in the art for the conventional scenario. So making it far worse by operating with a high-temperature, low-density SOL would be unacceptable. Hence new aspects are needed.

Finally, consider helium exhaust, SOL Issue #5. Helium is a unique impurity, unlike others because it is continuously generated inside the MC plasma by fusion reactions. As is widely recognized in the art, the SOL conditions are critical determinants of how efficiently the He ash can be removed from the system. Such removal is absolutely necessary: if helium is not removed efficiently, it would accumulate in the MC plasma and choke off the fusion reaction. In typical cases, this would happen in time as short as about a minute or so. This is obviously too short for a viable energy producing device.

Helium removal is accomplished in the standard scenario by pumping the helium out of the plasma chamber as a gas. Since helium is chemically inert and has an exceptionally low boiling point, such pumping is hard to do. It is well known in the art that relatively few types of pumps are suitable in a magnetic fusion environment. There are only two types that use well-developed technology. One type is called cryopumps which are used in present day MC experimental devices, and will also be used on ITER to remove the helium ash. The other type is a diffusion pump, probably using mercury as the working fluid. This pump also needs a quasi-cryogenic “cold trap”. For simplicity we shall say that all these pumps need a cryogenic region to operate.

In the standard scenario, the steps for removing helium are as follows. The helium is generated in the MC plasma, enters the SOL in an ionized state, and strikes the divertor target with the rest of SOL particles. Helium neutral gas is generated at the divertor target after the plasma particles strike it, in the usual process of recycling. This gas is transported through ducts to a pump with a cryogenic region outside the neutron shield. Such pumps must be located in a very low neutron flux region, since they have a cryogenic region, so that heating by neutrons is unacceptable. The neutron heating is extremely intense near the MC plasma, so the pump must be located behind considerable neutron shielding, and hence, must be a considerable distance away.

Of course, the pumps will only remove helium efficiently if the helium can be transported efficiently through the ducts, from the region where it is generated (the divertor target), to the pump location. In the standard scenario, this crucial step is greatly facilitated by an operating scenario with high SOL density, in the following way. The high SOL density leads directly to the neutral gas also having a high particle density, of both hydrogen and helium, and correspondingly, a mean free path that is less than the typical dimension of the duct. Within the terminology of the art, such a neutral gas is in the low Knudsen number regime. (The Knudsen number is the standard dimensionless fluid parameter, equal to the ratio of the mean free path for particle collisions with a characteristic relevant length of the system.) It is known that this greatly facilitates its transport through ducts. From a conceptual point of view, frequent collisions mean all the particles move together, as a bulk directed motion, and the walls of the duct are not a great impediment to transport through the duct.

If the neutral gas density was low, it is recognized in the art that the transport of the helium through ducts would be enormously reduced, making pumping inadequate. A low-density SOL would lead precisely to this unacceptable situation. Low density decreases the particle throughput, both by the direct effect of density, and also, indirectly by greatly increasing the mean free path. As it is referred to in the art, this is high Knudsen number flow. As is well known, a long duct has an enormously reduced conductance at high Knudsen number, since particles bounce off the walls and are randomized before reaching the end of the duct—the particles no longer move together in bulk motion (as is case with small mean free path). In a fusion reactor, this situation cannot be remedied by merely increasing the cross-sectional area of the duct, because this would also greatly increase the transport of neutrons down the duct, causing multiple unacceptable consequences: unacceptable heating of the cryogenic region needed by the pump, induced radio-activation and neutron damage of the components of the pump and its surroundings, and a reduction in tritium breeding for a deuterium-tritium fusion reactor.

So we see that all the SOL Issues become highly problematic in the conventional art, for a high-temperature, low-density SOL. We can readily see why these daunting SOL Issues lead the conventional approach to avoid a high-temperature, low-density edge.

Shunning the high-temperature, low-density regime, though reasonable in the conventional approach, comes with a high price.

As emphasized before, the conventional approach (with a low temperature edge) puts the entire burden of reaching high confinement upon the MC core region; the energy confinement and hence energy gain is, consequently, reduced. Devices to achieve high fusion gain, then, will require very large size, or high magnetic fields with expensive and massive coils. Either way, the cost of the device will be much higher than would be the case if our invention was employed.

The present invention offers solutions to the SOL Issues that arise from Plasma-Wall interactions for the high-temperature, low-density SOL.

Such an alternative (to the conventional approach) has been described in the previous art. Though a minority undertaking in the field, one such attempt that may create conditions closest to ones envisaged in this patent, uses lithium to reduce the SOL density by chemically absorbing hydrogenic species in the plasma when they strike it at the divertor target (or other surface in contact with the SOL). By hydrogenic, we will mean any of the isotopes of hydrogen: protium, deuterium, or tritium.

However, within the previous art, there is no satisfactory solution to the SOL Issues that will arise when lithium is used to reduce density. We consider each of the five SOL Issues in the context of lithium in the previous art:

Issue #1: Very high heat fluxes arise. No satisfactory resolution to this problem has been found in the previous art. The huge heat fluxes cause the surface temperature of the lithium to exceed tolerable limits that are rather low. Some estimate this as being 400-450 degrees C. (Castro 2021), but others estimate this as 300-380 C (Kessel 2019). Multiple undesirable effects follow from exceeding this temperature: high-evaporation, high-temperature-dependent sputtering, and reduction of the crucial chemical absorption of hydrogen. Numerous solutions, proposed to maintain a tolerable temperature of the lithium surface, have not yet been proven to be satisfactory The most discussed proposal is to have an extremely rapid flow of lithium through the region of high heat flux, so that the surface heating is limited by the transient exposure. But lithium is a highly electrically conducting metal; its rapid flow in a strong magnetic field is quite difficult. It is well known that making a high-conduction fluid move very rapidly in a region of high-magnetic field is exceptionally difficult because of rapid magnetic flow damping. Hence, attempts to make suitable rapid flows, with the high reliability needed to continuously handle very high heat fluxes, have not been successful yet. An additional problem is that radioactive tritium that is deposited in the lithium must be removed. For a fast-flowing stream, very large volumes of lithium must be processed, to remove very dilute concentrations of tritium, which is not easy.

Alternatively, maintaining an acceptable temperature of the lithium surface by cooling it from behind is very difficult. Several contributing reasons for this include a) the low tolerable surface temperature of lithium b) water cooling, although relatively efficient, cannot be used near lithium. Lithium burns violently in contact with water, and an accidental leak could lead to a substantial release of the radioactive tritium bound to the lithium, c) one cannot use materials in a fusion environment that would otherwise be beneficial for removing heat, such as copper, or aluminum. These are strongly degraded by neutrons in a fusion environment or are corroded by lithium.

It is conceivable that some future Flowing Liquid Surface Means becomes available to remove heat for a lithium divertor target. We will refer to this hypothetical technology as an FLSM. It is important to realize that even if an FLSM is somehow accomplished, it does not solve all the five SOL Issues, but only Issue #1 and Issue #3, and possibly Issue #2 and Issue #4, if other drawbacks were accepted. We will describe this below. But the present invention would still be needed for a working fusion reactor due to Issue #5. And the problems imposed by Issue #2 and Issue #4 can be onerous, so that the present invention would be a substantial improvement. The hypothetical FLSM would simply be operative at the divertor target, as one particular example, among many possibilities, of a divertor target where some of the surface is covered by liquid. But as we describe below, and as is manifest in the claims, the present invention is still beneficial and, in some cases, absolutely necessary, even if there is a hypothetical FLSM.

Issue #2: A low-density edge in an MC plasma leads to a VERY strong propensity for unacceptable impurity build-up within the plasma. This is especially well demonstrated in tokamak experiments with the highest energy confinement, that are in the what is called in the art the “H-mode”. Numerous analyses show that well understood physics, called neoclassical transport, leads to a large increase in impurity concentration in the MC core from the value in the SOL. Detailed quantitative comparisons with experiments show that this physics operates. The most careful analysis of experimental data states “The results indicate that turbulent transport is of negligible importance for the impurities at the edge transport barrier and thus, transport arrives at the neoclassical level” [Putterich 2011]. Thus, we can use neoclassical transport as a good guide to how impurities in the SOL get into the MC plasma. In present experiments, this causes the concentration of high Z impurities in the MC region to be increased by dozens or even nearly a hundred times compared to the concentration in SOL region. According to neoclassical dynamics, the propensity for impurities to concentrate in the core will become MUCH stronger as the SOL density decreases to the low values contemplated by using lithium. For the extremely low SOL densities under consideration, even moderately low levels of impurities in the SOL would build up in the MC region, even if slowly, but ultimately reaching unacceptable levels.

The most dangerous impurities are those with higher Z. These would arise from structural materials in the walls of the chamber of the MC plasma if there are high-energy particles incident upon it (unless those walls were coated with Li or Be or some other low Z material). But even low Z elements can build up to cause serious dilution of the fuel in the MC plasma.

In addition to impurities reaching the plasma through the SOL, they can reach it in other ways as well. One important way is that neutral impurities sputtered from the divertor target can enter the MC region along pathways that are not affected by the magnetic field, and become ionized, thereby becoming plasma impurities. When they are ionized near the edge, the neoclassical dynamics indicated above strongly concentrate them in the MC plasma core.

Another way that impurities can reach the plasma is by liquid droplets or solid flakes that drop from the wall into the plasma. These occur because of the huge volume of eroded material from the divertor target, which will accumulate around the entire interior of the machine over time. As these accumulations become thicker, eventually the material falls into the plasma.

Neutrals emitted from the SOL plasma near the divertor target (so-called charge exchanged hydrogenic neutrals) will travel along straight lines and sputter other materials in the interior of the machine, which are usually higher in Z. These impurities can enter the MC plasma, or, add to the redeposited material mentioned above.

Lithium has the lowest Z, and is the least dangerous impurity, but nonetheless it can become highly problematic, as the following numerical example shows. This example is merely for illustrative purposes and is not intended to be restricted to only this case. Neoclassical theory, and experimental experience with other low Z elements, imply that it is unlikely that the concentration of lithium in the MC plasma will be lower than the concentration in the SOL in steady state. Because of temperature dependent sputtering, measurement indicate that the lithium sputtering is ˜20% of the hydrogenic bombardment rate, for a lithium surface temperature possibly as low as 300 C (See, for example, Doerner 2001, FIG. 3). This may make the SOL about ˜20% Li. A concentration of 20% Li in the MC plasma would reduce the fusion power in the core by several fold due to dilution, and this is quite unacceptable. To prevent such a situation, the surface temperature of lithium in the divertor target must be limited to be very low. This would translate directly into a limitation on the heat flux incident upon the target.

To summarize the paragraph above, in order to solve Issue #2 according to the previous art, Issue #1 becomes much more difficult to solve. This is highly undesirable, since Issue #1 is already extremely challenging.

Issue #3: It is already appreciated in the art, that, for a divertor target, even a slowly flowing liquid can replenish eroded material at an adequate rate. This requires flow rates that are orders of magnitude lower than the flow rates needed to keep the lithium surface within its temperature limits. Such small flow rates appear practical. This would apply to lithium. So, a liquid lithium divertor target with slow flow would solve this problem.

Issue #4: There are some improvements compared to a solid divertor target, in that the liquid does not form dust. But there are still serious problems. The eroded material could rapidly accumulate over the rest of the plasma facing components as a liquid. This could disable Radio Frequency antennas, crucial diagnostics, and other equipment. It would accumulate, and drip down into undesired places, including the MC plasma. Such impurity injections into the MC region might very possibly quench the fusion.

These problems might be avoided if the walls of the fusion device were operated at sufficiently high temperature, the lithium would evaporate faster than it is deposited. This could eliminate Issue #4, but then Issue #2 becomes more problematic due to impurities generated by the wall. Or alternatively, the wall of the chamber of MC plasma could be coated with flowing lithium. But then the temperature of the wall is limited by evaporation and temperature dependent sputtering, and this then which limits the thermal conversion efficiency of the blanket that is connected to it. Reduced thermal conversion efficiency seriously degrades the economics of a fusion reactor, although a low wall temperature is acceptable for many test devices.

So to summarize the paragraph above, Issue #4 can be solved, but only at the expense of worsening other problems.

Issue #5: helium exhaust. If the divertor target is in the vicinity of the plasma X-point, as is typical in the conventional art, then a long duct must transport the helium from that vicinity to the pump, which in the standard art, must have a cryogenic region. As indicated above, for a low SOL density, helium is in the high Knudsen number regime. This leads to insufficient conductance through the duct to the pump. This cannot be remedied by increasing the cross-sectional area of the duct, because this would greatly increase the transport of neutrons down the duct, causing multiple unacceptable consequences: unacceptable heating of the cryogenic region, a reduction in tritium breeding for a deuterium-tritium fusion reactor, and induced radio-activation and damage of the components of the pump and its surroundings.

The ineluctable conclusion of the preceding discussion is that proposals to use lithium for a high-temperature, low-density edge have multiple serious problems, some of them fatal if it is employed according to the previous art. This is the judgement of many in the field, as can be seen by their actions. Analysis in the literature claims that lithium can greatly improve energy confinement, and hence, would make energy gain possible in devices that are far less expensive. Large reductions in cost are a strong driving force to adopt a technology that is deemed practical. Despite this, neither ITER nor SPARC, nor proposed fusion demonstration reactor designs from any major country include lithium for the purpose of greatly enhancing plasma energy confinement and reducing cost, including the K-DEMO project in South Korea or the CFETR project of China. Only the Tokamak Energy company is pursuing a lithium-based divertor for confinement enhancement.

Within the previous art, alternative liquid metals to lithium have been considered for the divertor target. Examples of such metals include, but are not limited to, molten tin, molten gallium and molten aluminum. These do not absorb hydrogenic species, and hence, do not, directly, lead to a low-density SOL plasma.

But let us assume that, somehow, a low-density plasma could be arranged by other means, such as the application of lithium in another area, or the use of other pumping means. An examination of the advantages and the disadvantages of liquid metals other than lithium in the context of the SOL Issues, reveals that although there are advantages regarding heat flux, the SOL Issues are still disqualifying.

Advantages of alternative liquid metals for the SOL Issues:

Heat flux (Issue #1): If the chosen material can operate with a much higher surface temperature than lithium, it will be much easier to tolerate the enormous heat fluxes at the divertor target (Issue #1). Alternative liquid metals have advantages here. Recent work as part of the EU fusion DEMO program has developed a design for a divertor where liquid tin faces the plasma, in a low-temperature, high-density SOL scenario called a high recycling regime [Rindt 2021]. It appears that liquid metals other than lithium may be capable of withstanding considerable heat flux. But some additional improvement would nonetheless be desirable. Such a solution is part of our invention.

Erosion (Issue #3): Even in a strong magnetic field, operation with a liquid metal flowing at a slow rate is permissible. Slowly flowing metal could, then, be employed to replenish the material eroded from the divertor target, as in the case of lithium.

Moderate disadvantages of alternative liquid metals in comparison to lithium:

Redeposition (Issue #4): There are some improvements compared to a solid divertor target, in that the liquid does not form dust. And, these metals would likely have much less evaporation than lithium, which would help with the materials redeposition. However, the unavoidable process of sputtering would still cause a lot of erosion and redeposition, if the SOL had a high temperature and low density. Much eroded material would still condense on the first wall of the MC plasma in inappropriate places. And after accumulating sufficiently, these deposits could fall into the plasma. Since these deposits are of a higher Z alternative metal, the plasma is far less tolerant of impurities than in the case of lithium.

On balance, alternative liquid metals to lithium would not, by themselves, resolve Issue #4.

Problems that are about the same:

Helium exhaust (Issue #5): There is a slight tendency for lithium to absorb helium, but this seems to be quite weak for high-temperature liquid lithium. One does not expect alternative liquid metals to absorb helium. So, this problem is about the same: there must still be a duct from the divertor region to a pump. For a low SOL density, the neutral gas in the duct is still in the high Knudsen number regime, which does not allow it to be adequately transported to the pump. Increasing the duct cross-sectional area does not lead to a satisfactory solution, since this would also lead to an unacceptably large neutron flux down the duct to the pump, leading to all the negative consequences described previously.

Severe disadvantages of alternative liquid metals:

Impurity accumulation in the MC plasma (Issue #2): These materials have a much higher atomic number Z than lithium. The neoclassical processes that produce a high concentration of the impurities in the MC region are even stronger when Z is larger (as is well known in the art). So, the alternate metals, with higher Z than lithium, concentrate more. To make matters worse, it is well known that the tolerable concentration impurities in the MC region is orders of magnitude smaller for higher Z impurities than for lower Z ones.

An additional issue arises for higher Z alternative metals. Once their atoms become ionized in the SOL, they can strike the divertor target and produce even more impurities. This is called self-sputtering, and each impurity atom can potentially lead to more than one new sputtered atom. The impurities would exponentially increase by this process, which is known within the art, and is called a self-sputtering avalanche. It leads to huge impurity generation. This obviously leads to unacceptably high impurity levels.

As before, sputtered impurities could reach the MC regions either via the SOL, or as sputtered neutral impurities that enter the MC region.

So, Issue #2 is far more problematic than in the case of lithium.

The invention disclosed here provides a solution to this issue.

In conclusion, within the previous art, there is no way to implement a high-temperature, low-density edge plasma that avoids all the disqualifying SOL Issues.

For reference, each of the following is incorporated herein in its entirety:
1—Castro 2021 “Lithium, a path to make fusion energy affordable”, Phys. Plasmas 28, 050901 (2021)
2—Doerner 2001 “Measurements of erosion mechanisms from solid and liquid materials in PISCES-B”, J. Nucl. Mater. 290-293 (2001)
3—Kessel 2019 “Critical Exploration of Liquid Metal Plasma-Facing Components in a Fusion Nuclear Science Facility”, Fusion Science and Technology, Vol 75 November 2019
4—Putterich 2011 “ELM flushing and impurity transport in the H-mode edge barrier in ASDEX Upgrade”, J. Nucl. Mater. S334-S339 (2011)
5—Rindt 2021 “Conceptual design of a liquid-metal divertor for the European DEMO”, Fusion Engineering and Design 173 (2021) 112812
6—Provisional patent application US 2010/0046688 A1 filed Aug. 25, 2008
7—U.S. Pat. No. 8,279,994 filed Oct. 10, 2008.

### SUMMARY OF THE INVENTION

While the way that the present invention addresses the disadvantages of the prior art will be discussed in greater detail below, in general, the present invention provides a way to operate with a Scrape Off Layer (hereafter called SOL) that has a high temperature and a low density, which will result in core energy confinement that is substantially enhanced.

The invention avoids the five disqualifying SOL Issues discussed in detail above; all these are repeated here for convenience:
1) Unacceptable heat flux on the wall, leading to unacceptable melting or evaporation of it
2) Unacceptable impurity accumulation in the MC plasma, due to sputtering and evaporation
3) Unacceptable erosion of the divertor target by sputtering or evaporation
4) Unacceptable redeposition of the eroded material in Issue #3
5) Unacceptably low helium exhaust

By having an SOL with high temperature and low density, while simultaneously avoiding the SOL Issues above, the invention will increase the energy gain from fusion of an MC plasma, and, it will allow high energy gain to be obtained from a much smaller MC plasma, so the device to operate this MC plasma will be far less expensive.

One aspect of the invention features a divertor target that is placed in a region where the total magnetic field strength is lower than at positions in the SOL between the target and the X point. This can be seen in FIG. 3 and FIG. 4, there the divertor target 105 is located at a larger major radius than the X-point, which often corresponds to a lower total magnetic field strength. The total magnetic field strength includes all components of the magnetic field, not just the components in the poloidal plane. By placing the divertor target in this way, there is a great reduction in impurity accumulation in the MC plasma, for physical reasons that are discussed below.

There are also surfaces in the divertor region that substantially block lines of sight from the divertor target to the MC plasma. We will call these a cover 107 in FIG. 3 and FIG. 5 and a shield 109 in FIG. 3, FIG. 4 and FIG. 5. In these figures, we also see that for some embodiments, the side of the 107 cover that faces the SOL has liquid 108 on at least some of it at least some of the time, and the side of the shield 109 that faces the SOL has liquid 111 on it at least some of the time.

In various embodiments, the liquid on the surface of the cover or shield facing the SOL could be a metal that is molten, including, but not limited to, lithium, tin, gallium, aluminum, beryllium, and alloys thereof. Lithium would chemically bind with hydrogenic neutrals emitted from the divertor target. All liquid metals could allow redeposited material to be removed, as long as it flowed with at least a slow rate. The liquid may be a metal that is molten all the time, or, only some of the time, to allow accumulated material to be periodically removed, or, eroded material to be periodically replenished.

In some embodiments, the strength of the magnetic field components in the poloidal plane (henceforth called the poloidal magnetic field) at the divetor target is larger than one third of the poloidal magnetic field along the Last Closed Flux Surface (LCFS) of the toroidally confined region. As described below, this produces a width of the SOL that is not much longer than the mean free path of neutrals that are emitted from the divertor target. This means that is that many of those neutrals can leave the SOL, with advantages for solving the SOL Issues that are described below. Examples of such neutrals are helium, higher Z impurities of the type that could lead to a self-sputtering avalanche if they were ionized, and also, in some embodiments, hydrogenic neutrals.

In other embodiments, the divertor target has substantial neutron absorbing material in between it and the magnetically confined plasma. For deuterium-tritium fusion, this could be the tritium breeding blanket containing lithium (Li⁶). Other neutron shielding materials could be used, either together with this, or by themselves, including, but not limited to, materials containing B¹⁰. Such materials might also partially surround the divertor region, in addition to being between it and the MC plasma.

In other embodiments, the surface of the divertor target facing the SOL is covered by liquids, that include, but are not limited to molten metals such as tin, gallium, aluminum, beryllium, lithium, and alloys thereof. The liquid may be a metal that is molten all the time. Or, for some metals, the metal may be molten only some of the time, to allow it to be periodically replenished or redistributed, examples of such metal include, but are not limited to, beryllium, aluminum, or alloys of these.

In other embodiments, there is a duct to pumping means for pumping helium or hydrogen, which is much shorter than in the standard art. A shorter duct conducts gas far better in the high Knudsen number flow regime. This allows for sufficient transport of helium from the region of the divertor target to the pump. In FIG. 3 and FIG. 4, we see that the entrance to the pumping duct has neutron absorbing material between it and the MC plasma, so that fewer neutrons enter the pumping duct. Therefore, the area of the duct can be increased to further improve helium transport, without incurring unacceptable neutron leakage through the duct to cryogenic regions or vacuum pumps, and without seriously degrading tritium breeding because of the loss of neutrons through the duct. Specifically, the distance from the divertor target to the pump is less than half of the distance from the plasma X-point to the pump, and, the divertor target has neutron absorbing material between it and the MC plasma that produces neutrons.

The purpose of this invention is to create a higher temperature at the edge of an MC plasma than is otherwise possible. So in other embodiments, the temperature of the electrons immediately adjacent to the divertor target is 25 electron Volts. By temperature, in the following we will mean ⅔ of the average energy. We note that much higher temperatures are possible, but this SOL temperature in the divertor region is already inaccessible to the standard art for fusion reactor relevant conditions, due to erosion and redeposition. In other embodiments, the temperature of the LCFS of the main plasma is 200 eV or higher. The latter is, however, much easier to measure. So we describe this requirement as an electron temperature above 200 eV on the last closed flux surface of the MC plasma or a temperature of electrons of 25 eV immediately adjacent to the divertor target.

In other embodiments, density of the MC plasma at the LCFS is much less than the line average density of the MC plasma. This is desirable for a high-energy confinement of the MC plasma, and is one major reason for having a low density SOL, since the SOL 103 is next to the LCFS 102. See FIG. 3-4. We describe this in terms of quantities that are easiest to measure, as a ratio of the electron density on the last close closed flux surface to the line averaged electron density of the MC plasma of 0.2 or less.

When these elements are combined, they result in embodiments that allows a high-temperature, low-density SOL plasma, while avoiding the disqualifying SOL Issues described in the section above, and which will increase the energy gain of the MC plasma, and also allow much smaller and cheaper devices to have high energy gain. Furthermore, as will be explained below, these elements tend to work together.

In other embodiments, the plasma purity is maintained at a level so that it can have fusion reactions. It is known in the art that there are several important aspects to purity, which we delineate as follows. In some embodiments, the purity can be maintained at a satisfactory level, so that there is not a build-up of photon radiation over time until eventually the fusion reactions drop by 40% or the temperature drops by 40%. Experiments find that excessive impurity accumulation in the MC plasma leads to such a drop, and this is one of the common signatures of excessive impurities. In other embodiments, the purity stays high so that radiation from the plasma is less than 70% of the heating power, where the heating power comprises the sum of externally applied heating and heating arising from nuclear reactions in the plasma. Photon radiation in MC plasmas is caused primarily from impurities, and excessive energy losses from these photons prevents the MC plasma from staying hot enough to give fusion. In yet other embodiments, the purity stays high so that the quantity known in the art as the effective Z, often dented by denoted by Z_{eff} in the art, stays below 3. It is known in the art that excessively high Z_{eff} makes it difficult to driven enough current in the MC plasma to maintain the magnetic configuration for long enough. The effective Z used here is an average over the MC plasma, and is defined as the ratio where the numerator is the sum of Nₛ Zₛ², where Nₛ is the number of ions of species s in the MC plasma, and Zₛ is the charge state of each plasma species s (that is the number of electrons lost from the atom), and the denominator is the sum of the number of electrons Nₑ in the MC plasma. In further embodiments yet, the purity of the MC plasma is such that there is little dilution of the fusion fuel, so that the fusion reaction rate is high. The specification for this is that for particles comprising the MC plasma, the sum of the electric charges of each fusion fuel ion is greater than 60% of the sum of the electric charge on all the electrons. Fusion fuel particles in a DT fuel cycle comprise deuterium and tritium, and in a D-He³ fuel cycle comprise deuterium and He³, and in a P-boron fuel cycle comprise protons and Boron.

This invention can be applied to magnetic geometries that include, but are not limited to, tokamaks, spherical tokamaks, stellarators, toroidal pinches, Reversed Field Pinches (RFP), Spheromaks, Field Reversed Configurations (FRC), as well as others. Examples of geometries that could benefit from application of this invention include, but are not limited to, the tokamak reactor ARC being designed by the Commonwealth Fusion Systems company in the USA, and spherical tokamak reactors such as the STEP device proposed by the United Kingdom Atomic Energy Agency and such as proposed by the Tokamak Energy company in the United Kingdom.

An example of a type of FRC reactor configuration that could benefit from application of this invention includes, but is not limited to, one disclosed in U.S. Pat. No. 11,337,294 which describes a device used in experiments by TAE Technologies Inc. to develop a nuclear fusion reactor for a FRC. The '294 patent describes how the experiment used an extremely thin layer of solid lithium in experimental shots that only lasted for several milliseconds. Our invention becomes valuable for shots that, in comparison to the experiments in '294, are 1) longer in duration, so that a thin solid coating of lithium would become saturated or eroded away 2) generate considerable neutrons or helium ash, and 3) have higher temperatures similar to a fusion reactor, that lead to higher sputtering and erosion. Such conditions will arise as the experimental parameters become closer to those of an energy producing fusion reactor.

One aspect of the invention features, in some embodiments, a toroidally confined plasma vessel including a toroidal plasma chamber and a magnetically confined plasma region where particles traveling along magnetic fields substantially never strike a wall. The magnetically confined plasma region is substantially symmetric by rotation around a central axis. The plasma vessel further includes a plurality of magnetic field coils and a divertor assembly with a divertor target. A plurality of magnetic field coils are configured to provide at least one X-point, and guide plasma particles from the magnetically confined region to the divertor target. The divertor target has a cover, wherein a side of the cover substantially facing the divertor target comprises a material that is liquid on at least some of the surface of the side of the cover for at least some of the time that the cover is in the toroidally confined plasma vessel. The total magnetic field strength (comprising all components of the magnetic field) at the divertor target is lower than the total magnetic field strength (comprising all components of the magnetic field) of a position between the divertor target and X-point on the last closed flux surface that is nearest to it; whereby at least one of: the radiation from the magnetically confined plasma does not increase in time until a 40 percent drop in the fusion rate in the magnetically confined plasma or until a 40 percent drop in the highest plasma temperature in the magnetically confined plasma, the power radiated from the magnetically confined plasma by photons does not exceed 70% of the heating power (where the heating power is the sum of externally applied heating plus the heating that arises from the nuclear reactions in the magnetically confined plasma), the effective Z is below 3 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.6 times the sum of the electric charges on all the electrons in the magnetically confined plasma.

In some embodiments, the divertor target has a shield that substantially blocks lines of sight from the divertor target to the magnetically confined plasma region and to important components that sustain operation of the device.

In some embodiments, the shield that substantially blocks lines of sight from the divertor target to the magnetically confined region and to important components that sustain the operation of the device is covered by liquid on the side substantially facing the divertor target for at least some of the time that the cover is in the toroidally confined plasma vessel.

In some embodiments, the component of the poloidal magnetic field, which is the component of the magnetic field in the plane perpendicular to the direction of rotation of the central axis, has a magnitude at the divertor target that is larger than one third of the maximum value of the poloidal magnetic field on the boundary of the magnetically confined plasma region.

In some embodiments, material that absorbs and slows down neutrons is located substantially in between the magnetically confined plasma region and the divertor target.

In some embodiments, the divertor target surface comprises a material that is liquid over at least some of the surface at least some of the time.

In some embodiments, the toroidally confined plasma vessel further includes a pumping duct extending from a position near the divertor target to a pumping means to pump out helium, hydrogen isotopes, other gasses, or any combination of these, and where a distance from the divertor target to the pumping means is less than one half of the distance from the X-point to said pumping means.

In some embodiments, at least one of: the electron temperature is above 200 eV at the boundary of the magnetically confined region or the temperature of electrons immediately adjacent to the divertor target is above 25 eV, and the ratio of the plasma electron density at the last closed flux surface to the line averaged electron density for a chord passing near the center of the magnetically confined plasma is less than 0.2.

In some embodiments, at least one of: the electron temperature is above 1000 eV at the boundary of the magnetically confined region, the temperature of electrons immediately adjacent to the divertor target is above 100 eV, and wherein the ratio of the plasma electron density at the last closed flux surface to the line averaged electron density for a chord passing near the center of the magnetically confined plasma is less than 0.15.

In some embodiments, at least one of: the radiation from the magnetically confined plasma does not increase in time until a 20 percent drop in the fusion rate in the magnetically confined plasma or until a 20 percent drop in the highest plasma temperature in the magnetically confined plasma, the power radiated from the magnetically confined plasma by photons does not exceed 50% of the heating power (where the heating power is the sum of externally applied heating plus the heating that arises from the nuclear reactions in the magnetically confined plasma), the effective Z is below 2.5 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.75 times the sum of the electric charges on all the electrons in the magnetically confined plasma.

Another aspect of the invention features, in some embodiments, a toroidally confined plasma vessel including a toroidal plasma chamber and a magnetically confined plasma region where particles traveling along magnetic fields substantially never strike a wall, wherein the magnetically confined plasma region is substantially symmetric by rotation around a central axis. The plasma vessel further includes a plurality of magnetic field coils, a divertor assembly with a divertor target, and wherein a plurality of magnetic field coils are configured to provide at least one X-point and guide plasma particles from the magnetically confined region to the divertor target. At least one of: the electron temperature is above 200 eV at the boundary of the magnetically confined region, the temperature of electrons immediately adjacent to the divertor target is above 25 eV, and the ratio of the plasma electron density at the last closed flux surface to the line averaged electron density for a chord passing near the center of the magnetically confined plasma is less than 0.2. The divertor target, on the surface facing the plasma, comprises a material that is liquid at least some of the time and whose composition is less than 50% lithium by atomic fraction. The total magnetic field strength (comprising all components of the magnetic field) at the divertor target is lower than the total magnetic field strength (comprising all components of the magnetic field) of a position in the SOL between the divertor target and X-point on the last closed flux surface that is nearest to it; whereby at least one of: the radiation from the magnetically confined plasma does not increase in time until a 40 percent drop in the fusion rate in the magnetically confined plasma or until a 40 percent drop in the highest plasma temperature in the magnetically confined plasma, the power radiated from the magnetically confined plasma by photons does not exceed 70% of the heating power (where the heating power is the sum of externally applied heating plus the heating that arises from the nuclear reactions in the magnetically confined plasma), the effective Z is below 3 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.6 times the sum of the electric charges on all the electrons in the magnetically confined plasma.

In some embodiments, the divertor target comprises a cover, wherein a side of the cover substantially facing the divertor target comprises a material that is liquid on at least some of the surface of the side of the cover.

In some embodiments, material that absorbs and slows down neutrons is located substantially in between the magnetically confined plasma region and the divertor target.

In some embodiments, the toroidally confined plasma vessel further includes a pumping duct extending from a position near the divertor target to a pumping means to pump out helium or hydrogen isotopes, other gasses, or any combination of these, and where a distance from the divertor target to the pumping means is less than one half of the distance from the X-point to said pumping means.

In some embodiments, the component of the poloidal magnetic field, which is the component of the magnetic field in the plane perpendicular to the direction of rotation of the central axis, has a magnitude at the divertor target that is larger than one third of the maximum poloidal magnetic field around the boundary of the magnetically confined plasma region.

In some embodiments, a shield that substantially blocks lines of sight from the divertor target to the magnetically confined region and to important components that sustain the operation of the device is covered by liquid on a side of the shield substantially facing the divertor target.

In some embodiments, at least one of: the electron temperature is above 1000 eV at the boundary of the magnetically confined region, the temperature of electrons immediately adjacent to the divertor target is above 50 eV, and the ratio of the plasma electron density at the last closed flux surface to the line averaged electron density for a chord passing near the center of the magnetically confined plasma is less than 0.15.

In some embodiments, at least one of: the radiation from the magnetically confined plasma does not increase in time until a 20 percent drop in the fusion rate in the magnetically confined plasma or until a 20 percent drop in the highest plasma temperature in the magnetically confined plasma, the power radiated from the magnetically confined plasma by photons does not exceed 50% of the heating power (where the heating power is the sum of externally applied heating plus the heating that arises from the nuclear reactions in the magnetically confined plasma), the effective Z is below 2.5 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.75 times the sum of the electric charges on all the electrons in the magnetically confined plasma.

### BRIEF DESCRIPTION OF THE DRAWINGS

FIG. 1A gives an example from the prior art and also gives a graphical example of the terminology used in the descriptions. This terminology is standard within the art. The surfaces that are tangential to the magnetic field are flux surfaces. The plasma particles travel mainly within these surfaces and move relatively slowly across them. The geometry is approximately a torus, and so, there is an approximate axis of revolution. The distance of a point from this axis is referred to as the major radius of the point. A plane such as is shown in FIG. 1A, in which the axis of revolution lies, is referred to as a poloidal plane. The magnetic field component that lies in this plane is called the poloidal magnetic field. The Last Closed Flux Surface (LCFS) 102 has one or more X-points 120 on it where the poloidal magnetic field vanishes. It is well known in the art that the flux surfaces at an X-point form an “X”, as shown. The region inside of the LCFS 101 is the Magnetically Confined plasma, or MC plasma. It is also well known in the art that a high-temperature SOL plasma has most of the heat and particles substantially bounded between two flux surfaces, one being the extension of the LCFS 130, called the separatrix within the art, and the other being the bounding SOL surface 103.

The SOL plasma strikes a material surface at the strike point 104 and 140, and the material surface is called the divertor target 105 and 150, which is also shown. Each X-point has two divertor targets associated with it, one of which is further from the axis of rotation 105, called the outboard divertor, and most of the particles and energy flow to this target. The other divertor is referred to as the inboard divertor target 150.

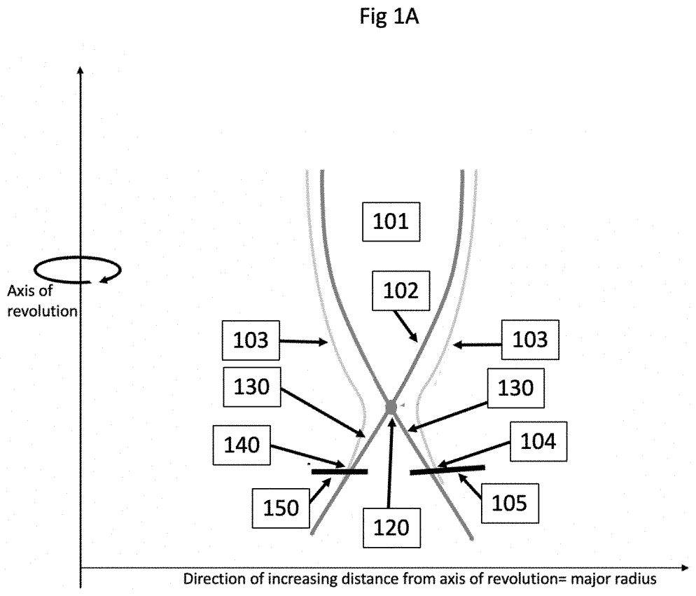

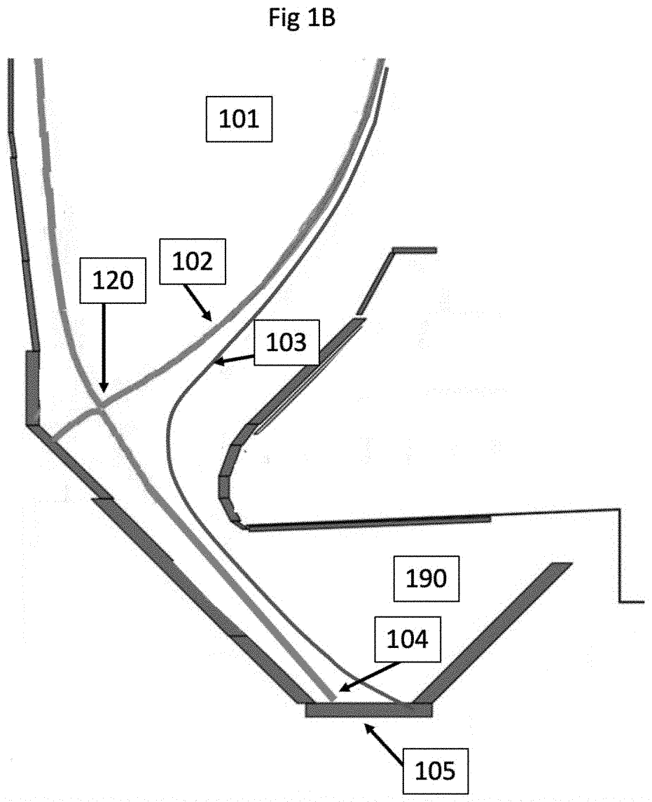

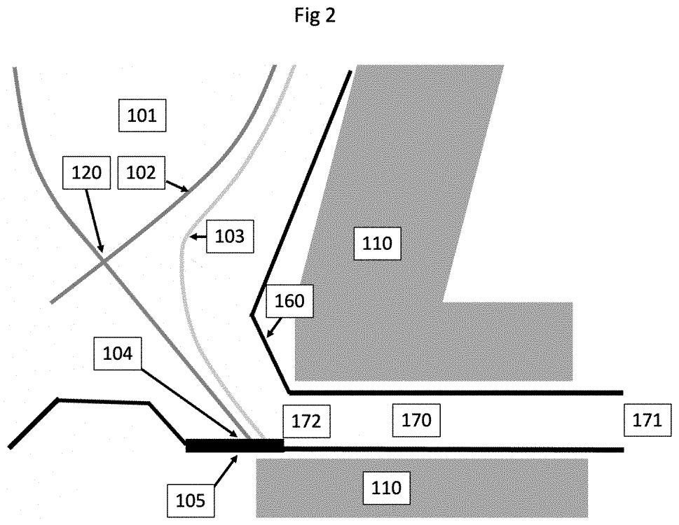

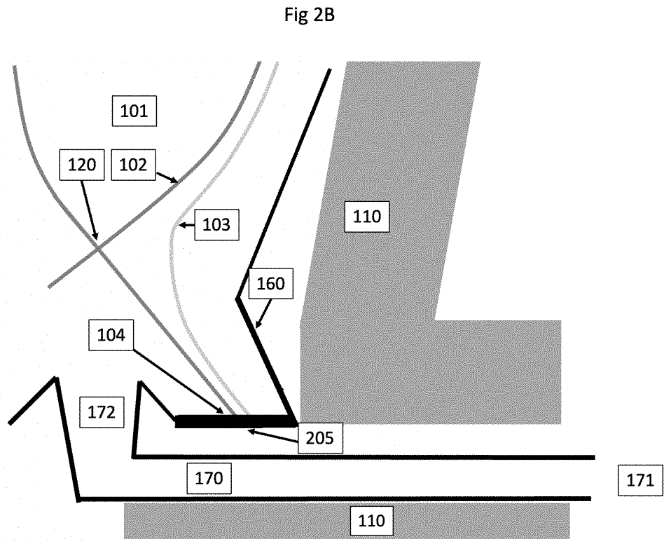

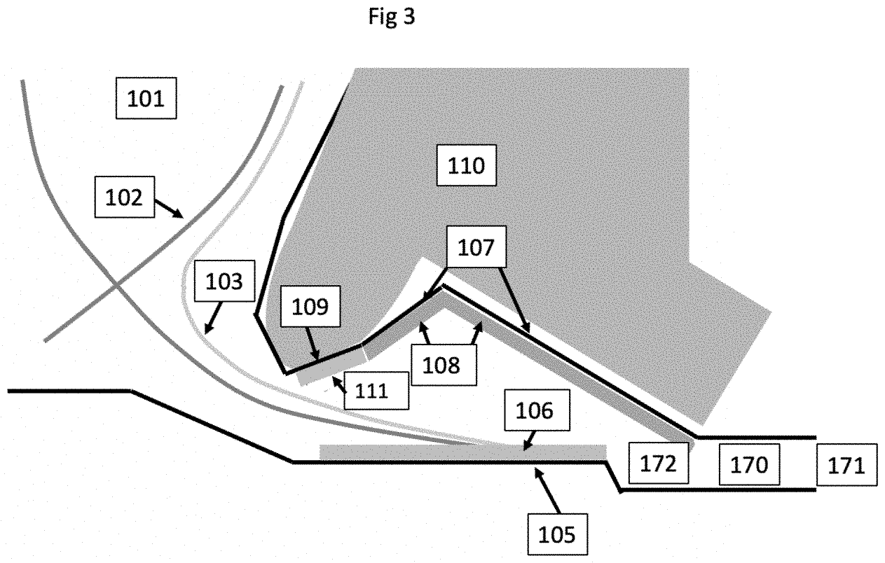

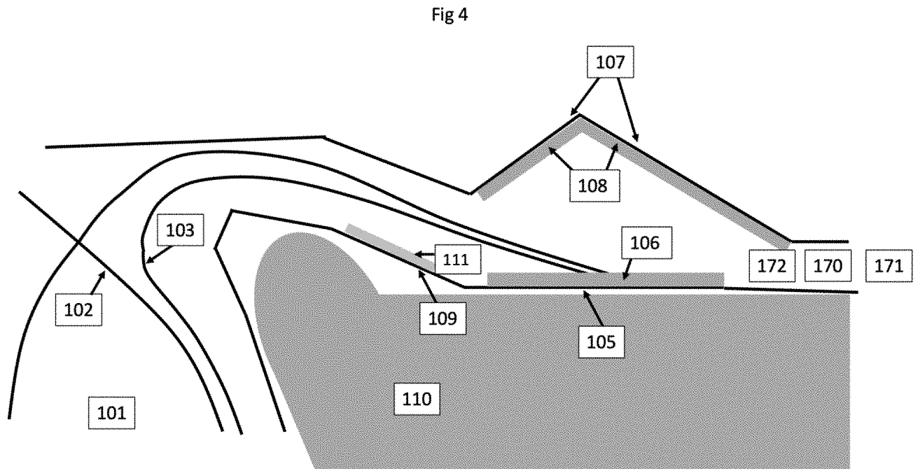

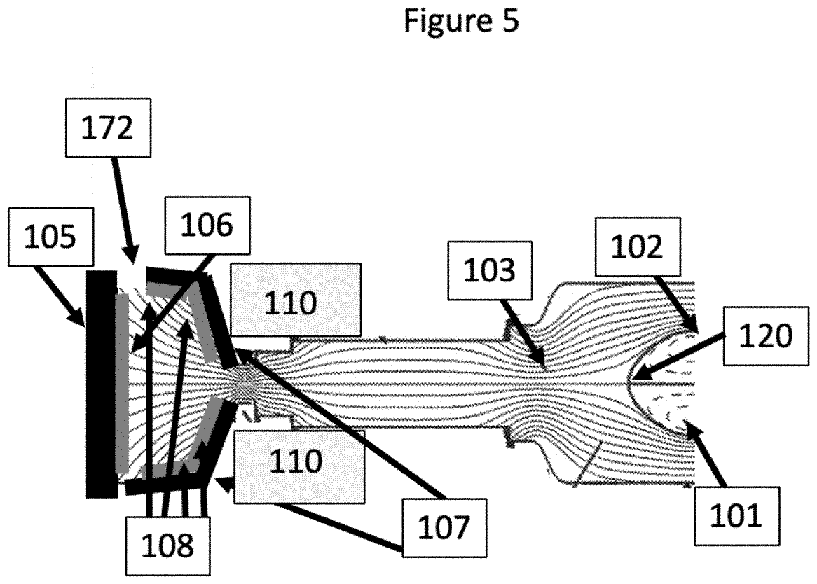

In FIG. 1A, the X-point is at the bottom of the plasma; this configuration is called, in the art, a “lower null”. A configuration where the divertor is near an X-point at the top of the plasma is called an “upper null”.

In FIG. 1B is another geometry from the prior art, called a Super-X divertor. Shown is an actual geometry for a device that has been constructed in the United Kingdom called MAST-U. It shows the MC plasma 101, the LCFS 102, the lower X-point 120, the bounding surface of most of the SOL 103, the strike point 104 and the divertor target 105. The divertor target and the SOL near it are contained in a divertor chamber 190.

FIG. 2 is of the prior art, and is a close-up of a conventional outboard divertor region, for a “lower null” configuration, which shows how neutral gas is pumped. It shows the MC plasma 101, the LCFS 102, the lower X-point 120, the bounding surface of most of the SOL 103, the strike point 104 and the divertor target 105. Walls of the region containing the plasma 160 are shown. Neutral gas particles arise in the region of the divertor target and must be removed by being pumped out. This is accomplished by having a pumping duct 170 with an entrance 172 in the divertor region and at the end of which is a pumping means 171 that pumps out neutral particles. Neutrons generated in the MC plasma 101 are absorbed by neutron absorbing material 110 that generally surrounds the MC plasma 101, but the entrance to the divertor region does not have significant neutron absorbing material between it and the MC plasma.

FIG. 2B is of the prior art, and has a pumping duct arrangement similar to the ITER device, that differs from the one in FIG. 2. It shows the MC plasma 101, the LCFS 102, the lower X-point 120, the bounding surface of most of the SOL 103 and the divertor target 105. Walls of the region containing the plasma 160 are shown. Neutral gas particles arise in the region of the divertor target and must be removed by being pumped out. This is accomplished by having a pumping duct 170 with an entrance 172 in the divertor region and at the end of which is a pumping means 171 that pumps out neutral particles. Neutrons generated in the MC plasma 101 are absorbed by neutron absorbing material 110 that generally surrounds the MC plasma 101, but the entrance to the divertor region does not have significant neutron absorbing material between it and the MC plasma.

FIG. 3 gives an example of one embodiment of the invention disclosed here, when there is a lower null. There are numerous differences from the prior art that are explained in the detailed description section below. The figure shows the MC plasma 101, the LCFS 102, the bounding SOL surface 103, the divertor target 105, the pumping duct 170, the entrance to the pumping duct 172 and the pumping means 171. New aspects include a material on the divertor target facing the SOL that is liquid at least some of the time 106, a cover 107, material facing the SOL on top of the cover that is liquid at least some of the time 108, the shield 109, and material facing the SOL on top of the shield that is liquid at least some of the time 111. Also shown is neutron absorbing material 110 that is between the MC plasma and the both the divertor target 105 and the entrance of the pumping duct 172.

In other embodiments of the invention, there would be an X-point at the top of the upper half. This case is an example of an “upper null”, shown in FIG. 4. The figure shows the MC plasma 101, the LCFS 102, the bounding SOL surface 103, the divertor target 105, the pumping duct 170, the entrance to the pumping duct 172 and the pumping means 171. New aspects include a material on the divertor target facing the SOL that is liquid at least some of the time 106, a cover 107, material facing the SOL on top of the cover that is liquid at least some of the time 108, the shield 109, and material facing the SOL on top of the shield that is liquid at least some of the time 111. Also shown is neutron absorbing material 110 that is between the MC plasma and the both the divertor target 105 and the entrance of the pumping duct 172.

Some magnetic geometries have two X-points on (or very near to) the LCFS, where one is near the top and one is near the bottom. This is called a “double null” in the art. In this circumstance, an exemplary embodiment of the invention could have the lower divertor region such as FIG. 3, and an upper divertor region such as FIG. 4.

These figures are for magnetic configurations of the MC plasma that might be a tokamak, spherical tokamak, a toroidal pinch or a Reversed Field Pinch (RFP). The invention can also apply to other magnetic configurations such as a Field Reversed Configuration (FRC) or a spheromak, as well as others. An example of aspects of the invention applied to an FRC is seen in FIG. 5. The magnetic field configuration is taken from U.S. Pat. No. 11,337,294 (specifically FIG. 2 of that patent). Aspects of that figure that are extraneous to the considerations related to this patent have been omitted for clarity. FIG. 5 shows the MC plasma 101, the LCFS 102, the SOL boundary 103, the divertor target 105 and a cover 107. New aspects include a material on the divertor target facing the SOL that is liquid at least some of the time 106, material facing the SOL on top of the cover that is liquid at least some of the time 108. Also shown is neutron absorbing material 110 that is between the MC plasma and the entrance of the pumping duct 172.

### DETAILED DESCRIPTION

Some embodiments of the invention are for magnetic geometries that are a lower single null. Other embodiments are for magnetic geometries with an upper single null. Yet other embodiments of this invention employ a double null geometry.

Note that in the specific case of double null geometries, the invention differs in numerous respects from the US Patent application by Buxton et. al. that also applies to double null geometries (US 20210265068A1, Pub. No.: US2021/0265068A1). The essence of our invention, and its operation, is quite different from Buxton et. al. The purpose of the present invention is to find a solution to the SOL Issues described above. The purpose of the Buxton invention is to find a way to apply a liquid metal divertor target to a double null geometry, and, as is implicitly implied by the claims, to use gravity to assist in the flow of that liquid (since the flow the inlet must be above the outlet in Buxton). Most of the SOL Issues that motivate the present invention are not even mentioned in the Buxton patent. Thus, many of the aspects of this invention, which are for the purpose of solving the SOL Issues, are not present in the Buxton invention. And solving the SOL Issues does not require a double null geometry, which is the essence of the Buxton patent. Furthermore, using gravity to assist in the flow of a liquid metal is not in any way crucial for our invention. For example, the heat can be removed by conduction through a liquid metal to a heat sink behind it, without using gravitationally assisted flow at all. So as can be readily appreciated, this invention is very different from Buxton.

Some embodiments of the invention apply to cases of a single lower null and cases of a single upper null. As another example, our invention addresses the issues of sputtering, erosion, and helium, dwells upon these at length in the descriptions, and these issues motivate many of the claims. But in Buxton, the terms sputtering, erosion and helium appear only once each in parenthetical comments, and certainly do not motivate any of the clams. Furthermore, note that in Buxton et. al., the liquid flow has an inlet above where the outlet is. But our invention can have a divertor target that can be substantially horizontal to promote a smooth surface. Our invention only requires a slow flow of liquid on the divertor target in order to replenish eroded material, and this can readily be provided without gravitational assistance, for example, by using capillary action, or by electromagnetic means, or by other means, so that a flow inlet above the outlet is not required for our invention.

Buxton is largely immaterial to the operation of our invention. The essence of this invention is quite different from Buxton et. al, and the claims of our invention apply to very many cases where Buxton does not apply. Nonetheless, it is possible that some embodiments of our invention could be double null geometries with the liquid flow inlet above the outlet.

There are several key insights that motivate our invention. Firstly, the goal is to produce a high-temperature, low-density SOL in a practical way, that is, so that all the disqualifying SOL Issues are resolved. This will then lead to a higher energy confinement time, higher fusion gain, and fusion gain in smaller devices.

The following insights, not in the previous art, show that there are regimes where certain physical dynamics in the SOL can operate to advantage. The various aspects of the invention cause the favorable physical dynamics to be actually manifest, and hence, allow a MC plasma with high-energy confinement by avoiding the SOL Issues. Other additional aspects are also helpful to allowing the SOL Issues to be further resolved.

Two key physical dynamics, that the aspects of the invention will cause to operate to advantage, are described below. These dynamics motivate some of the key features of this invention, so we discuss them below. We distinguish these two by referring to them as dynamics number one and dynamics number two.

1) The following section describes dynamics number one and its ramifications.

Our analysis shows that by placing the divertor target in a region of lower magnetic field strength B, a strong electrostatic potential arises that has the effect of preventing impurities generated at the divertor target from reaching the MC plasma. The electrostatic potential, in effect, shields the MC plasma from the damaging impurities that are generated near the divertor target. These impurities would otherwise become ionized and travel along magnetic field lines to reach the MC plasma. This dynamic has not been used to advantage in the art, to the authors knowledge, until this disclosure.

Note that this dynamic only occurs in an SOL with a high-temperature, low-density SOL, which is the regime of interest in this invention. Specifically, this electrostatic potential is strong when the mean free path for Coulomb collisions is longer than characteristic distance traveled by a particle going along a magnetic field line from the divertor target to the MC plasma. Such a long mean free path arises in an SOL with high-temperature and low density. This electrostatic potential is far weaker in the conventional operating regime of a divertor, which is the opposite: the low temperature and high-density of such regimes (as in MAST-U and many other cases within the art) results in a short mean free path.

It appears to be true that, since the fusion community has concentrated its attention primarily on the regime of short Coulomb collisional mean free path, the ability of this electrostatic potential, in the long mean free path regime, to help prevent contamination of the MC plasma, has not been recognized until this disclosure. The patent arranges aspects of the invention to use this dynamic advantageously.

The following explains how this is done. In the regime of interest to this invention, the magnitude of the potential difference along a magnetic field line between point 1 and point 2 is very roughly of a magnitude ˜(Tₑ/e) ln(B₁/B₂), where Tₑ is the electron SOL temperature, e is the charge on the electron, B₁ is the total magnetic field strength at point 1 and B₂ is the total magnetic field strength at point 2, and ln is the natural logarithm.

A potential with the magnitude of Tₑ will have a very large impact on the path of an impurity in this regime. Impurities in the SOL plasma are generated by sputtering or evaporation or recycling, and in all these cases the energy of the impurity is in the range of several eV or less. This invention applies to SOL where Tₑ is about 200 eV or more, which is far greater than the energy of the impurities. In this case, the potential can prevent impurities from reaching the MC plasma. Impurities are positively charged, so the sign of the electrostatic potential will do just that when the divertor target is in region where B is relatively small in comparison to other positions between the divertor target and the MC plasma.

Also, if the Coulomb collisional mean free path is long, the electrostatic potential reflects impurities back to the divertor on a time scale much shorter than the time for the impurity to be heated by the SOL plasma to a high enough energy so that the impurity can overcome the electrostatic potential. Such heating is only strong enough in the regime of short mean free path, which is the opposite of the one considered in this invention.

To summarize the preceding few paragraphs: in the regime of density and temperature for this embodiment of the invention, the MC plasma is insulated from impurities generated in the SOL at the divertor target, if the target is in a region of relatively low total magnetic field strength. This is of crucial importance to avoid contamination of the MC plasma, since as we have described before, experiments and neoclassical transport say that impurities in the SOL can be strongly concentrated in the MC plasma.

Hence, an aspect of the invention is that the magnetic field strength at the divertor target is less than the strength as some position in the SOL between the target and the X-point of the MC plasma.

The impurities for which this desirable dynamic applies include impurities generated by sputtering, by evaporation, and by recycling, and including, but are not limited to, elements of the materials that face the plasma, and helium, and impurities arising from small leaks of air or other gasses into the chamber of the plasma.

As the preceding paragraphs make clear, one of the essential goals of this invention is to prevent unacceptable impurity contamination of the MC plasma. Impurities have several serious negative affects upon the plasma, which are known in the prior art. An appropriate way to specify the purity of the MC plasma is to specify that those negative effects are small. So we describe the purity of the plasma in terms that the following four deleterious effects from impurities must be small. 1) In experiments, one important way that excessive contamination is manifest is that the radiation from the plasma grows in time until it becomes excessive and there is a collapse of the MC plasma temperature or fusion rate. So we specify the condition of low impurities in the claims the same way: the radiation from the magnetically confined plasma is not increasing in time until a specified percentage drop in the plasma temperature in the magnetically confined region or a drop in the fusion rate. A percentage drop that exceeds this would significantly impair the operation of the device. 2) Another important way that impurities degrade the MC plasma is by producing radiation power losses from it that become a large fraction of the heating power, so that the heating power becomes inadequate to sustain sufficiently high temperature. We describe this in the claims by saying that the power radiated from the MC plasma by photons must not exceed a numerical fraction of the heating power, where the heating power is the sum of externally applied heating plus the heating that arises from the nuclear reactions in the MC plasma. If the radiation exceeds this fraction the operation of the device would be significantly impaired. 3) Another way that impurities can degrade the plasma is by increasing its electrical resistance so that it is difficult to drive necessary current. It is known in the prior art that the electrical resistance is closely related to the effective Z. Hence the effective Z must stay below a numerically specified value, above which operation of the MC plasma would be significantly impaired. The effective Z used here is an average over the MC plasma, and is defined as the ratio where the numerator is the sum of Nₛ times Zₛ², where Nₛ is the number of ions of species sin the MC plasma, and Zₛ² is square of the charge state of each plasma species s (the charge state is the number of electrons lost from the atom), and the denominator is the sum of the number of electrons Nₑ in the MC plasma. 4) A further way that impurities can degrade operation is by diluting the fusion fuel so that the fusion reaction rate is reduced. Within the art, the dilution of the fusion fuel is often specified in relative terms as the number of fuel ions compared to the number of electrons. In a perfectly pure plasma, the charge on all of the fuel ions would equal to the charge on all the electrons. Impurities reduce the fuel ions and the total charge they carry. So we specify a low dilution of an MC plasma by saying that the sum of the electric charges of each fusion fuel ion is greater than a specified fraction of the sum of the electric charge on all the electrons. Dilution greater than this would significantly impair the operation of the device.

We now turn to the subject of how the aspects that lead to the electrostatic potential also make it easier to attain other benefits for solving the SOL Issues, so that they work advantageously together.

The magnetic field strength in tokamaks, in the SOL, usually decreases with increasing major radius. Hence, in order to apply the dynamic above advantageously, it is often the case that the divertor target 105 must be at a larger distance from the MC plasma 101. See FIG. 3 and FIG. 4. And note that the entrance to the pumping duct 172 must be fairly close to the divertor target 105. This brings another advantage, applicable to helium pumping: the entrance to the pumping duct 172 is considerably further from the MC plasma, and hence closer to the pumps 171. Thus, the duct to the pump 170 can be shorter, improving the transport of helium through the ducts to the pumps for its removal. This addresses a substantial problem, described before, in a regime where the SOL density is low: helium transport through ducts is relatively poor.

Another aspect of the geometry mentioned above can further be advantageous for helium pumping: if the divertor target 105 is located some distance away from the MC plasma, it is possible to put the target in a region of low neutron flux, because there is sufficient space to place neutron absorbing materials 110 between the divertor target 105 and the MC plasma 101 that generates neutrons. Thus, less neutrons enter the pumping duct entrance 172. So it is possible to have a pumping duct 170 that has a larger cross-sectional area, without an unacceptable number of neutrons being transmitted through the duct to overheat cryogenic regions of the pumps 172, or to degrade the vacuum pumps themselves. This further improves helium transport through the ducts. Divertor configurations that are standard in the art, as in FIG. 2, have the entrance to the duct 172 in a much higher neutron flux, and so the ducts cannot have too large an area to allow excessive neutrons to travel through the ducts.

So summarizing the paragraphs above, a number of important advantageous aspects can work together in the invention that is disclosed here.

Regarding the advantage of a shorter duct described above, in the claims, we refer to this by saying that the distance between the divertor target and the pump is shorter than half of the distance between the X-point and the pump.

This concludes the section that describes the dynamics number one, as defined above, and all the ways that it can contribute advantageously to the operation of the device.

2) The following paragraphs describe dynamics number two, as defined above, that the claims will cause to be advantageous to the operation of the device:

For parameters of an energy gain device, there are magnetic field geometries, together with parameters of SOL temperature and density, that have another important property: neutral atoms and molecules have a relatively long mean free path in the SOL, so that many of them pass through the SOL without being ionized. Specifically, when this applies in the divertor region, then many of the neutrals generated at the divertor target tend to go through the SOL and remain as neutral particles. These neutrals include both recycled hydrogen, helium and sputtered impurities. This is highly beneficial for reasons explained below. So an aspect of this device is to cause the width of the SOL to be less than the mean free path of neutrals generated at the divertor plate, so that many of the neutrals pass through the SOL.

One reason that this is beneficial is this: in order to achieve a low-density SOL, it is not necessary to place a chemical absorbing material like lithium at the divertor target 105, where heat fluxes are very high. Instead, such absorbing material can be placed at a different location than the divertor target, where the heat flux is far lower. For example, in some embodiments, the cover 107 can have a liquid lithium surface facing the SOL 108. Or in other embodiments, the shield 109 can have a liquid lithium surface facing the SOL 111. Or in other embodiments, the neutrals could enter the duct at 172, travel through the duct 170, and be removed by the pumps 171. In fact, in some embodiments, there can be no chemical absorbing material at all, and other reliable pumping means that are known in the art can remove the neutrals, such as diffusion pumps or cryopumps.

Recall that a central feature of the previous art for obtaining a low-density, high-temperature SOL was to use lithium at the divertor target. And recall that this leads to major problems in the previous art: because of the high-heat fluxes at the divertor target, it is very difficult to maintain a surface temperature that is low enough to be acceptable for lithium (which some estimate as 400-450 degrees C. and others estimate as 300-380 C). These problems can be avoided in the present invention, because lithium need not be at the divertor target, as described in the paragraph above.

In summary, an SOL that is not too wide allows important advantages: we can separate two critical functions a) withstanding high-heat flux, and b) pumping of plasma particles to maintain a low density. Splitting these functions allows one to use appropriate materials and means for the optimal effectiveness of each of these crucial functions, rather than having to use lithium for both. One can use a material for the divertor target other than lithium, that can withstand higher temperatures. This is a major benefit since there is no material or means which is optimal at both functions simultaneously for conditions of a practical fusion device. And, to reiterate, this separation of functions becomes possible when width of the SOL is not too much longer than the mean free path of the neutrals.

An additional important advantage of an SOL that is not much larger than the mean free path is the following: it becomes possible to avoid self-sputtering avalanches, even for materials whose self-sputtering coefficient is greater than one at the high-SOL temperature. This allows a much wider class of materials to be considered for the divertor plate, some of which, have a much more favorable operating temperature range, or other advantages. Recall what this avalanche is: ionized impurities are accelerated to high-energy in the SOL, and when they impact the plate, they create more than one neutral impurity atom. Evidently, this can lead to exponential growth: the avalanche. However, in the present geometry, many of the neutral sputtered atoms pass through the SOL without being ionized. Hence, they will not be accelerated to an energy where they cause high-self-sputtering. Thus, self-sputtering avalanches are avoided because many sputtered impurities avoid the crucial step of being ionized in the SOL and hence being accelerated to high-energy.

A further additional important advantage of operating in a regime where the SOL width is less than the mean free path is that it becomes much easier to pump the helium ash. To effectively pump helium, the pressure of neutral helium must be high-enough in the divertor region to create a high-enough pressure in the pump region. Some of this neutral helium will be ionized in the SOL, and tends to contribute to plasma contamination. By having the SOL be thin, the amount of such ionization is lower. This implies that a higher density of neutral He can be present in the divertor region, which will make it easier to pump the helium in the pump region.

To summarize the paragraphs above, several benefits accrue to having the SOL width not be much longer than the particle mean free path. A narrow SOL near the diverter target, is obviously beneficial for this. Importantly, this condition is not usually the case in the conventional art: the plasma SOL width near the divertor target is, generally, quite wide. This is because in the conventional art, the divertor target is usually not far from the MC plasma X-point, and the SOL is very wide in this region.

The present invention employs a configuration of magnetic fields other than the usual one in the prior art in order to have this characteristic. To see how this is done, one first derives a criterion for a relatively narrow SOL width using methods well known in the art.

Particles in the SOL follow the magnetic fields, especially at high-temperature and low density. So the width w of the SOL follows the width of the region between flux surfaces that bound it. This implies w varies as 1/(B_pol_R), where R is the major radius of the position and B_pol is the poloidal component of the magnetic field, that is, the component of the magnetic field in the plane that is perpendicular to the direction of revolution around the axis.

A conventional divertor geometry has the divertor target 105 considerably closer to the vicinity of a plasma X-point 120 (See FIG. 2) in comparison with embodiments of this invention (FIG. 3 and FIG. 4). The X-point is the position on the LCFS where the poloidal magnetic field vanishes. For the conventional geometry, where each divertor target is in the vicinity of an X-point, the B_pol is rather small at the divertor target. Hence, such a divertor would have a large SOL width, and would not be able to access the advantages of a low SOL width.

To avoid the large SOL width of the conventional divertor geometry, at least one divertor target must be placed at a different position from the conventional geometry. In the art, it is known that each X-point has two divertor targets associated with it, one with a larger major radius R than the other. Most of the heat and particles flow to the outer divertor target with larger R, called the outer divertor target.

So we give a specification that the poloidal magnetic field at the outer divertor target, such that is must not be too small. The specification is as follows, and, is based upon the B_pol at the outer divertor target: for this invention, at the position of at least one outer divertor target, the poloidal magnetic field must be at least as large as a factor times the largest value, anywhere on the LCFS of the MC plasma, of the poloidal magnetic field. A good value for that factor is ⅓.

The requirement that the divertor target is located away from the X-point also has the consequence that it is easier to locate the target in a region that accesses dynamic number one described above, namely, that the divertor target is in a region of low total magnetic field strength, since: if the target were close to the X-point, it would be difficult to locate it in a region where the total magnetic field strength at the target was different from the value at the X-point or any other point in between. Hence, requirements for dynamics one and dynamics two work together advantageously to a significant extent.

In addition, locating the divertor target at a position away from the LCFS X-point, there is space to put neutron absorbing materials between the MC plasma and the divertor target, so that there is a lower neutron flux at the divertor target. This has the same benefits of a low neutron flux as in section 1) above. This is another way that aspects of this invention work together advantageously.

Some additional key aspects of the invention assist in allowing all the SOL Issues to be solved simultaneously:

3) If the SOL is narrow near the divertor target, as described above, this tends to concentrate heat, which makes solving Issue #1 more difficult. It is well known in the art that to spread out the heat flux, one can make the magnetic field nearly tangential to the plate. It is recognized in the art that this spreads out the heat by an amount that is inversely proportional to sin(theta), where theta is the angle of the magnetic field with the plate. It is also well known in the art that unevenness in the target plate limits how small the angle can be. Hence, unevenness in the plate limits the degree to which the heat flux can be reduced. Such unevenness arises in mechanical designs for conventional high-heat flux divertors, for example, on ITER. These designs have divertor surfaces consisting of many so called “monoblocks” that are not perfectly aligned. For ITER, due to this unevenness, the minimum allowed angle theta is roughly 2 to 3 degrees. Improved mechanical designs, such as those suggested for the Fusion Nuclear Facility by the General Atomic company, allow values of theta which are lower: roughly one degree. This angle would give lower heat flux. However, even this low of an angle might not be enough for needed reduction in heat flux.

So, it is desirable to have a divertor plate that avoids unevenness, that is, it is smoother, so that the heat can be spread even more.

For this, the present invention uses the elementary fact that liquid surfaces are smooth, as long as they do not flow too quickly and become turbulent. Hence, the claims include liquid surfaces 106 for the divertor target 105, in FIG. 3, FIG. 4 and FIG. 5. This helps solve SOL issue #1. A smooth liquid surface arises for a nearly horizontal plate of very slowly moving liquid. It is also known in the art that magnetic fields make liquid metal flows much more laminar, which can also enhance smoothness. Sufficiently slowly flowing liquid metals in a magnetic field can maintain high-smoothness, even for some degree or departure from purely horizontal. Hence, in some embodiments, this invention can have flowing liquid surfaces on the divertor target.

As is known in the art, Capillary Pore Systems (hereafter called CPS), if made of a fine enough mesh, can also have very smooth liquid surfaces. Hence, in other embodiments, the present invention can also use liquid surfaces in this manner, that is, with liquid in a CPS.

So in summary, this invention uses liquid surfaces that have the advantage of allowing a smoother surface to spread heat out more. This works advantageously with another advantage of liquids that was mentioned previously: liquids allow replenishment of the surfaces that are eroded quickly, such as the divertor target.

Another way to make a smooth surface is to have a molten metal that covers the divertor target and slowly cools to solidify. In other words, the divertor target does not need to always be a liquid. It might only be a liquid for some of the time, to allow the creation of a solidified surface that is very smooth.

In some embodiments, heat that strikes the divertor target could be removed by cooling from behind the surface of the divertor target facing the SOL. This is well known in the art for solid divertor targets. In other embodiments, if a practical means of creating rapidly flowing liquid metal to remove heat in a divertor becomes available, that might also be used for this surface. In yet other embodiments, a combination of these two methods could be used.

4) Many of the sputtered or evaporated impurities are entirely neutral, and travel along substantially straight lines (they do not respond to the magnetic field). These impurities originate mainly at the divertor target 105, or from material that covers the divertor target 106. These impurities could get into the MC plasma 101 and contaminate it. Hence, an additional aspect of the invention is to avoid lines of sight from the divertor target to the MC plasma, by employing a material surface to block them. We will call this a shield 109 which can be seen in FIG. 3 and FIG. 4.

In some embodiments, such as FIG. 3, the shield 109 is an extension of the cover 107. The cover already blocks many lines of sight from the divertor target to the MC plasma, and the shield blocks additional lines of sight from the divertor target to the MC plasma. In other embodiments, such as FIG. 4, the cover 107 does not block lines of sight to the MC plasma, and the shield 109 does this.

By blocking sputtered and evaporated material, the cover 107 and shield 109 also avoids the accumulation of that redeposited material in undesired places around the plasma chamber. Accumulation of material on walls around the MC plasma, or other locations where it would cause problems is, thereby, prevented.

The cover must also have an opening which allows particles to escape and be pumped out. This opening is the entrance to the duct 172 and is connected to the duct 170 which has pumping means 171 at the end. These particles that must be pumped may include helium, and possibly also hydrogenic particles, and possibly other particles as well.

5) The cover 107 and shield 109 described in 4), in addition to blocking sputtered and evaporated material from the MC plasma, can have other functions as well. These can be realized by having a further aspect of the invention be that a liquid surface 108 on the cover 107 faces the SOL, and a liquid surface 111 on the shield 109 faces the SOL. The material facing the SOL must be a liquid at least some of the time, and over at least some of the surface. The liquid could have several benefits, which we now describe.

One benefit is obtained if the liquid is lithium, so that it would chemically bind with recycled hydrogen. This could produce the low-density, high-temperature SOL. Since neither the cover nor the shield is subject to the enormous heat fluxes at the divertor target, it is far easier to keep the lithium in a temperature range where the chemical binding is very strong, and where evaporation and temperature dependent sputtering is low. Hence placing the liquid lithium surface 108 or 111 at a location other than the divertor target, therefore, has important advantages.

There are other benefits that the liquid can confer. These functions could be obtained by liquids such as molten metals, including, but not limited to, lithium tin, gallium, lead, and alloys containing these. To see the function of these liquids, realize that the cover and shield would be subject to accumulation of redeposited sputtered material from the divertor target. Consequently, they could accumulate a problematic thickness of this redeposited material over time. This liquid 108 and 111 would allow accumulated material to be removed, for example by pumping the liquid through pipes, without having to replace any solid part of the divertor. The flow rates required for this are rather low. As mentioned before, replacement of such solid parts is typically very time consuming, and is estimated to take on the order of months. Removal of material through pipes is much faster and easier and does not require any maintenance shut-down.

An additional benefit that the liquid 108 and 111 can confer is that the liquid can be replenished easily, even by a slow liquid flow. This is important because there can be considerable erosion when a high temperature SOL is nearby, since there will be some high energy neutrals that arise by charge exchange of recycled neutrals with the SOL plasma. The high energy neutrals will strike and erode the material of the cover 107 and the shield 109. By having liquid 108 on the surface of the cover 107 or liquid 111 on the surface of the shield 109, this eroded material could be replenished easily.

Also, transient events in the MC plasma can cause erosion because of high energy fluxes to be deposited on the divertor target, cover and shield. By having these components covered with liquid, that material can be replenished by a slow liquid flow.

The liquid surface might be continuously flowing. Then the redeposited material would dissolve in the liquid and be removed continuously. Or the surface could be solid most of the time, and liquid would flow only for relatively short periods to periodically dissolve and remove the accumulated material.

6) Aspect 3 above indicated the advantages of having a divertor target that is liquid. However, a solid target is still possible. Due to erosion, however, the lifetime of such a target would be limited. Hence, the divertor target might be solid most of the time, but would only be liquid to allow eroded material to be replaced and to make the surface smooth flat again when the liquid solidifies. This could happen during brief shutdowns of the MC plasma operation. The replenishing material could be introduced, for example, through pipes, while keeping the divertor target in place.

This technique, allowing a solid divertor target surface to be replenished and made smooth without removing it, works much faster than removing the solid target; the latter is estimated to take months.

7) The physical arrangement described by all the aspects above lends itself to placing neutron shielding around the diverter region. To see this, note that by being in a region with larger magnetic field strength than at the X-point, the divertor target must be located a significant distance away. It is also true that the requirement on the poloidal magnetic field described above tends to place the divertor target away from the plasma X-point. Either of these considerations implies a location for the divertor target 105 where there is space between the divertor target and the MC plasma 101, and neutron absorbing material 110 can be placed in that space. See FIG. 3 and FIG. 4.

For a deuterium-tritium reactor, the neutron shield could be the tritium breeding blanket that contains the neutron absorber Lib. Other neutron shielding means can also be used, as well, either in conjunction with a lithium breeding blanket or instead of it, using materials including, but not limited to, those that contain B¹⁰. Such materials might also partially surround the divertor region, in addition to being between it and the MC plasma.

Also, the neutron absorber 110 will reduce the neutron flux from the MC plasma 101 to the divertor target 105. See FIG. 3 and FIG. 4. Several major benefits for the divertor target can result.

One of these is that materials with very high-thermal conductivity can be used, which remove heat more efficiently, but which are rapidly degraded by neutrons. Some examples of such material that are known in the art include, but are not limited to, copper and copper alloys, forms of carbon, graphite, and carbon composites, and forms of silicon carbide and silicon carbide composites. These have high-thermal conductivity and other desirable properties but degrade rapidly in a flux of fusion neutrons. But because the divertor target in this invention can have substantial neutron shielding, the use of these, and other, materials becomes possible. These materials can remove high-heat flux more efficiently and can have other advantages such as corrosion resistance.

The low neutron flux might also make it possible to use better coolants in the divertor region. As mentioned above, a water coolant, which is used in ITER because of its efficiency, would present a serious risk of accidental lithium fire if lithium is present in the divertor region. If neutron bombardment is small, various liquids with low melting points becomes available, that are not dangerous in contact with lithium. These liquids would be degraded by a large flux of neutrons. Such liquids include, but are not limited to, silicon-based liquids, mineral oils, synthetic oils, some molten salts, or other liquids. These liquids have desirable properties, but either degrade quickly, or, produce undesirable radioactive byproducts, when exposed to neutrons. So by putting the divertor target in a low neutron flux region, the use of these coolants becomes possible.

Because of these aspects in 7) and possibly 3), it might become easier to employ a lithium divertor target, despite the low surface temperature limit.

8) The intent of the present invention is to create an SOL where the average electron energy is higher than is possible with conventional means. So, we include this as a separate claim.

In some embodiments, the temperature of the electrons immediately adjacent to the divertor target must exceed 25 electron Volts. Temperatures of this range would cause unacceptable erosion in a solid target for operation at high duty cycles. We note that much higher temperatures are possible, but this SOL temperature in the divertor region is already inaccessible to the standard art for fusion relevant conditions and operation for long times. In other embodiments, the temperature of the LCFS next to the main plasma is 200 eV or higher. So, we describe this requirement as an electron temperature above 200 eV on the last closed flux surface of the MC plasma or a temperature of electrons of 25 eV immediately adjacent to the divertor target.

We note that it is sometimes technically difficult to precisely measure the SOL electron temperature. It is easier to measure the SOL temperature near the LCFS next to the MC plasma. This is another reason to describe this requirement as an electron temperature of at the LCFS near the MC plasma, in addition to as an SOL temperature immediately adjacent to the divertor target.

In other embodiments, density of the MC plasma at the LCFS is much less than the line average density of the MC plasma. This is also desirable for a high energy confinement. We describe this in terms of quantities that are easiest to measure, as a ratio of the electron density on the last close closed flux surface to the line averaged electron density of the MC plasma of 0.2 or less.

Before proceeding to the claims, we mention two important points. 1) It is hypothetically conceivable that some future Flowing Liquid Surface Means becomes available, that could resolve the surface heat flux issue. We will refer to this hypothetical future technology as an FLSM. It is important to realize that even if an FLSM is somehow accomplished, it does not solve all the five SOL Issues, but only, perhaps, Issue #1 and Issue #3. Hence the present invention would still be needed for a working fusion reactor or neutron source for transmutation. Aspects and claims of the present invention would still be necessary. The hypothetical FLSM would simply be operative at the divertor target, as one specific example, among many possibilities, of what is termed in the claims as a divertor target where some of the surface is covered by liquid at least some of the time.

2) Commercially, applications of MC plasma may be classified in two types with different goals. The first type has a high duty cycle, that is, the MC device operates for a substantial fraction of the time. Devices to produce useful energy or neutron sources for transmutation are of the high duty cycle type. The second type of device has low duty cycle. These can operate in the pulse mode—pulses lasting seconds or minutes, followed by long periods with no operation. Devices with low duty cycle are often research devices that are prototypes to develop devices of the first type. Examples of commercial devices with short duty cycle are SPARC, soon to be built by the company Commonwealth Fusion Systems, and ST40, presently being operated by Tokamak Energy Ltd. Government operated research devices such as ITER are also of the second type.

For short duty cycle devices, target erosion (Issue #3) and redeposition (Issue #4) may not be so serious, because these problems accumulate over days of continuous divertor target operation. However, the issue of heat flux (Issue #1) and impurity accumulation (Issue #2) are still critical. And depending upon the research device, helium exhaust (Issue #5) may or may not be important for a research device. It is definitely important for ITER, but it is not for ST40, and it is probably somewhat important, but not crucially important, for SPARC. Furthermore, for short duty cycle devices, some produce a substantial flux of neutrons (e.g. ITER and SPARC) that can impact the pumping means, and some do not (e.g. ST40). Recall from the discussions above that neutrons can be highly problematic for the pumping means, so that it is very beneficial to put neutron absorbing materials between the source of the neutrons and the entrance to the pumping duct. These is not important for research devices that do not produce neutrons.

We can apply the present invention to devices with both low duty cycle and high duty cycle. The latter must have more aspects than the former, in order to better resolve Issue #3 and Issue #4. And Issue #5, while crucial for a high duty cycle device, is not important for some research devices.

The claims below are organized to reflect this, with some dependent claims that are important for devices of type 1) but not of type 2).

1. A toroidally confined plasma vessel comprising:
a toroidal plasma chamber;
a magnetically confined plasma region where particles traveling along magnetic fields substantially never strike a wall;
where the magnetically confined plasma region is substantially symmetric by rotation around a central axis;
a plurality of magnetic field coils;
a divertor assembly with a divertor target;
wherein a plurality of magnetic field coils are configured to provide at least one X-point, and guide plasma particles from the magnetically confined region to the divertor target;
wherein the divertor target has a cover, wherein a side of the cover substantially facing the divertor target comprises a material that is liquid on at least some of the surface of the side of the cover for at least some of the time that the cover is in the toroidally confined plasma vessel;
wherein the total magnetic field strength (comprising all components of the magnetic field) at the divertor target is lower than the total magnetic field strength (comprising all components of the magnetic field) of a position between the divertor target and X-point on the last closed flux surface that is nearest to it;
whereby at least one of: the radiation from the magnetically confined plasma does not increase in time until a 40 percent drop in the fusion rate in the magnetically confined plasma or until a 40 percent drop in the highest plasma temperature in the magnetically confined plasma, the power radiated from the magnetically confined plasma by photons does not exceed 70% of the heating power (where the heating power is the sum of externally applied heating plus the heating that arises from the nuclear reactions in the magnetically confined plasma), the effective Z is below 3 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.6 times the sum of the electric charges on all the electrons in the magnetically confined plasma.

2. The toroidally confined plasma vessel of claim 1, wherein the divertor target has a shield that substantially blocks lines of sight from the divertor target to the magnetically confined plasma region and to important components that sustain operation of the device.

3. The toroidally confined plasma vessel of claim 2, wherein the shield that substantially blocks lines of sight from the divertor target to the magnetically confined region and to important components that sustain the operation of the device is covered by liquid on the side substantially facing the divertor target for at least some of the time that the cover is in the toroidally confined plasma vessel.

4. The toroidally confined plasma vessel of claim 1, wherein the component of the poloidal magnetic field, which is the component of the magnetic field in the plane perpendicular to the direction of rotation of the central axis, has a magnitude at the divertor target that is larger than one third of the maximum value of the poloidal magnetic field on the boundary of the magnetically confined plasma region.

5. The toroidally confined plasma vessel of claim 1, wherein material that absorbs and slows down neutrons is located substantially in between the magnetically confined plasma region and the divertor target.

6. The toroidally confined plasma vessel of claim 1, wherein the divertor target surface comprises a material that is liquid over at least some of the surface at least some of the time.

7. The toroidally confined plasma vessel of claim 1, further comprising a pumping duct extending from a position near the divertor target to a pumping means to pump out helium, hydrogen isotopes, other gasses, or any combination of these, and where a distance from the divertor target to the pumping means is less than one half of the distance from the X-point to said pumping means.

8. The toroidally confined plasma vessel of claim 1, wherein at least one of: the electron temperature is above 200 eV at the boundary of the magnetically confined region or the temperature of electrons immediately adjacent to the divertor target is above 25 eV, and the ratio of the plasma electron density at the last closed flux surface to the line averaged electron density for a chord passing near the center of the magnetically confined plasma is less than 0.2.

9. The toroidally confined plasma vessel of claim 1, wherein at least one of: the electron temperature is above 1000 eV at the boundary of the magnetically confined region, the temperature of electrons immediately adjacent to the divertor target is above 100 eV, and wherein the ratio of the plasma electron density at the last closed flux surface to the line averaged electron density for a chord passing near the center of the magnetically confined plasma is less than 0.15.

10. The toroidally confined plasma vessel of claim 1, wherein at least one of: the radiation from the magnetically confined plasma does not increase in time until a 20 percent drop in the fusion rate in the magnetically confined plasma or until a 20 percent drop in the highest plasma temperature in the magnetically confined plasma, the power radiated from the magnetically confined plasma by photons does not exceed 50% of the heating power (where the heating power is the sum of externally applied heating plus the heating that arises from the nuclear reactions in the magnetically confined plasma), the effective Z is below 2.5 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.75 times the sum of the electric charges on all the electrons in the magnetically confined plasma.

11. A toroidally confined plasma vessel comprising:
a toroidal plasma chamber;
a magnetically confined plasma region where particles traveling along magnetic fields substantially never strike a wall;
wherein the magnetically confined plasma region is substantially symmetric by rotation around a central axis;
a plurality of magnetic field coils;
a divertor assembly with a divertor target;
wherein a plurality of magnetic field coils is configured to provide at least one X-point and guide plasma particles from the magnetically confined region to the divertor target;
wherein at least one of: the electron temperature is above 200 eV at the boundary of the magnetically confined region, the temperature of electrons immediately adjacent to the divertor target is above 25 eV, and the ratio of the plasma electron density at the last closed flux surface to the line averaged electron density for a chord passing near the center of the magnetically confined plasma is less than 0.2;
wherein the divertor target, on the surface facing the plasma, comprises a material that is liquid at least some of the time and whose composition is less than 50% lithium by atomic fraction;
wherein the total magnetic field strength (comprising all components of the magnetic field) at the divertor target is lower than the total magnetic field strength (comprising all components of the magnetic field) of a position in the SOL between the divertor target and X-point on the last closed flux surface that is nearest to it;
whereby at least one of: the radiation from the magnetically confined plasma does not increase in time until a 40 percent drop in the fusion rate in the magnetically confined plasma or until a 40 percent drop in the highest plasma temperature in the magnetically confined plasma, the power radiated from the magnetically confined plasma by photons does not exceed 70% of the heating power (where the heating power is the sum of externally applied heating plus the heating that arises from the nuclear reactions in the magnetically confined plasma), the effective Z is below 3 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.6 times the sum of the electric charges on all the electrons in the magnetically confined plasma.

12. The toroidally confined plasma vessel of claim 11, wherein the divertor target comprises a cover, wherein a side of the cover substantially facing the divertor target comprises a material that is liquid on at least some of the surface of the side of the cover.

13. The toroidally confined plasma vessel of claim 11, wherein material that absorbs and slows down neutrons is located substantially in between the magnetically confined plasma region and the divertor target.

14. The toroidally confined plasma vessel of claim 11, further comprising a pumping duct extending from a position near the divertor target to a pumping means to pump out helium or hydrogen isotopes, other gasses, or any combination of these, and where a distance from the divertor target to the pumping means is less than one half of the distance from the X-point to said pumping means.

15. The toroidally confined plasma vessel of claim 11, wherein the component of the poloidal magnetic field, which is the component of the magnetic field in the plane perpendicular to the direction of rotation of the central axis, has a magnitude at the divertor target that is larger than one third of the maximum poloidal magnetic field around the boundary of the magnetically confined plasma region.

16. The toroidally confined plasma vessel of claim 11, wherein a shield that substantially blocks lines of sight from the divertor target to the magnetically confined region and to important components that sustain the operation of the device is covered by liquid on a side of the shield substantially facing the divertor target.

17. The toroidally confined plasma vessel of claim 11, wherein at least one of: the electron temperature is above 1000 eV at the boundary of the magnetically confined region, the temperature of electrons immediately adjacent to the divertor target is above 50 eV, and the ratio of the plasma electron density at the last closed flux surface to the line averaged electron density for a chord passing near the center of the magnetically confined plasma is less than 0.15.

18. The toroidally confined plasma vessel of claim 11, wherein at least one of: the radiation from the magnetically confined plasma does not increase in time until a 20 percent drop in the fusion rate in the magnetically confined plasma or until a 20 percent drop in the highest plasma temperature in the magnetically confined plasma, the power radiated from the magnetically confined plasma by photons does not exceed 50% of the heating power (where the heating power is the sum of externally applied heating plus the heating that arises from the nuclear reactions in the magnetically confined plasma), the effective Z is below 2.5 (where the effective Z is defined as the ratio where the numerator is the sum over all ions in the magnetically confined region times the square of the charge state of the ion and the denominator is the total number of electrons in the magnetically confined plasma), and the sum of the electric charges of fusion fuel ions in the magnetically confined plasma is greater than 0.75 times the sum of the electric charges on all the electrons in the magnetically confined plasma.
